(19) United States
(12) Patent Application Publication
(10) Pub. No.: US 2015/0037572 A1
(43) Pub. Date: Feb. 5, 2015

(54) SURFACE PROTECTIVE FILM AND OPTICAL COMPONENT

(71) Applicant: NITTO DENKO CORPORATION, Ibaraki-shi (JP)

(72) Inventors: Tatsumi Amano, Ibaraki-shi (JP); Kenjiro Niimi, Ibaraki-shi (JP); Kazuma Mitsui, Ibaraki-shi (JP)

(21) Appl. No.: 14/339,646

(22) Filed: Jul. 24, 2014

(30) Foreign Application Priority Data
Jul. 30, 2013 (JP) 2013-158188

(51) Int. Cl. B32B 27/08; C09J 7/02; G02F 1/00; B32B 7/12; B32B 27/36

(52) U.S. Cl. CPC B32B 27/08; B32B 7/12; B32B 27/36; G02F 1/0072; C09J 7/0217; C09J 7/0285; C09J 7/0246; B32B 2255/10; B32B 2405/00; B32B 2551/00; B32B 2307/412; B32B 2255/26; B32B 2307/584; C09J 133/12
USPC 428/354; 428/480

(57) ABSTRACT

Provided is a surface protective film, which has a substrate having a topcoat layer containing a lubricating property imparting component and rarely whitened and an adhesive layer formed of a water dispersible acrylic adhesive composition, and which is excellent in removability etc. A surface protective film having: a substrate; and a topcoat layer and an acrylic adhesive layer formed on respective faces of the substrate, in which the topcoat layer contains a lubricant wax composed of a higher fatty acid/higher alcohol ester and a polyester binder resin, the acrylic adhesive layer is formed of a water dispersible acrylic adhesive composition containing an acrylic emulsion polymer obtained by polymerization of an alkyl (meth)acrylate (A) and a carboxyl group-containing unsaturated monomer (B) with a reactive emulsifier.

### TECHNICAL FIELD

The present invention relates to a surface protective film which is laminated to an object (object to be protected) and protects the surface of the object.

### BACKGROUND ART

The surface protective film (also referred to as a surface protective sheet) is generally constituted of a film-like substrate (support) and an adhesive (pressure-sensitive adhesive) provided on the substrate. Such a protective film is laminated to an object with the adhesive, and in this way, the protective film is used for protecting the object from being scratched and stained during e.g., processing and transportation. For example, a polarizing plate, which is to be laminated to liquid crystal cells in producing liquid crystal display panels, is once produced in a roll form, and then the roll is wound off and cut into pieces of a desired size so as to correspond with the shape of the liquid crystal cells, and then put in use. Here, in order to protect the polarizing plate from being scratched in intermediate steps by abrasion with a transfer roll, etc., a surface protective film is laminated to one side or both sides (particularly one side) of the polarizing plate, as a countermeasure. As such a surface protective film, for example, a surface protective film having a coat layer on one side of the faces of a substrate and an adhesive layer on the other side of the faces of the substrate, is mentioned (see, Patent Literatures 1 and 2).

In such a surface protective film, as a composition used for forming the adhesive layer, a water dispersible adhesive composition has come to be used in consideration of a working environment during coating.

### CITATION LIST

### Patent Literature

Patent Literature 1: Japanese Patent Laid-Open No. 2009-107329

Patent Literature 2: Japanese Patent Laid-Open No. 2011-20348

### SUMMARY OF INVENTION

### Technical Problem

As such a surface protective film, a transparent film is preferably used since the appearance inspection of an object (for example, polarizing plate) can be performed with the film laminated thereto. Recently, in consideration of e.g., easiness of the appearance inspection and inspection accuracy, the level of quality required for appearance of the surface protective film has been increased. For example, the back face (opposite face to the surface onto which an object is to be laminated) of a surface protective film is required to be resistant to a scratch. This is because if a scratch is present on the surface protective film, it cannot be determined which of the object and the surface protective film the scratch is formed on, with the surface protective film kept laminated to the object.

As one of the approaches for protecting the back face of a surface protective film from being scratched, providing a hard surface layer (topcoat layer) to the back face is mentioned. Such a topcoat layer is formed, for example, by applying a coating material to the back face of a substrate, drying and hardening it. It is advantageous if the topcoat layer has appropriate lubricating property, in realizing a further higher scratch-resistant property (scratch resistance, i.e., property of a surface impervious to being scratched). This is because, due to the lubricating property, stress that may possibly be applied if the topcoat layer is scratched can be released along the surface of the topcoat layer. As an additive (lubricant) for imparting the lubricating property to the topcoat layer, e.g., a silicone lubricant (for example, a silicone compound such as polyether-modified polydimethyl siloxane) and a fluorine lubricant are generally used.

However, the present inventors found that a substrate having a topcoat layer containing a silicone lubricant is easily whitened, which is a phenomenon (called whitening) in which an object looks white in appearance, depending upon the storage conditions (for example, an object is stored under high-temperature and high-humidity conditions). If the substrate of the surface protective film is whitened, the following problem occurs: visibility of the surface of an object reduces through the surface protective film. Then, for example, it leads to the following problem in some cases: if the appearance of the object is inspected with the surface protective film laminated thereto, the inspection accuracy reduces.

Further, such a surface protective film is required to have sufficient adhesiveness while it is laminated to an object and have excellent peel property (removability) because it is removed from the object after laminating a purpose of use. In order to have excellent removability, it is required not only that the film is removed by applying small peel force (lightly removed) but also that adhesive force (peel force) rarely increases (ability to prevent adhesive force from increasing) with the passage of time after laminated to an object.

Accordingly, an object of the present invention is to provide a surface protective film, which has a substrate having a topcoat layer containing a lubricating property-imparting component and rarely whitened and an adhesive layer formed of a water dispersible acrylic adhesive composition, and which is excellent in removability and scratch resistance.

### Solution to Problem

The present inventors have intensively conducted studies with the view to attaining the above object. As a result, they found that in a surface protective film having a substrate having first and second faces, a topcoat layer formed on the first face of the substrate and an acrylic adhesive layer formed on the second face of the substrate, if a predetermined topcoat layer is employed as the topcoat layer and an acrylic adhesive layer formed of a predetermined water dispersible acrylic adhesive composition is employed as the acrylic adhesive layer, a surface protective film excellent in whitening resistance, scratch resistance and removability, can be obtained. Based on the finding, the present invention was accomplished.

More specifically, the present invention provides a surface protective film having:

a substrate having a first face and a second face;

a topcoat layer formed on the first face of the substrate; and

an acrylic adhesive layer formed on the second face of the substrate, in which

the topcoat layer contains a wax serving as a lubricant and a polyester resin serving as a binder,

the wax is an ester of a higher fatty acid and a higher alcohol, and

the acrylic adhesive layer is an adhesive layer formed of a water dispersible acrylic adhesive composition, which contains:

an acrylic emulsion polymer which is constituted of, as essential raw-material monomers, an alkyl (meth)acrylate (A) and a carboxyl group-containing unsaturated monomer (B), the content of the alkyl (meth)acrylate (A) being 70 wt % to 99.5 wt % and the content of the carboxyl group-containing unsaturated monomer (B) being 0.5 wt % to 10 wt %, based on the total amount of the raw-material monomers, and which is obtained by polymerization using a reactive emulsifier containing a radical polymerizable functional group in a molecule.

It is preferable that the substrate be a polyester resin film.

It is preferable that the topcoat layer contain an antistatic component.

It is preferable that the water dispersible acrylic adhesive composition further contain a water-insoluble crosslinking agent containing not less than two functional groups capable of reacting with a carboxyl group in a molecule.

It is preferable that the acrylic emulsion polymer be an acrylic emulsion polymer constituted of an alkyl (meth)acrylate (A), a carboxyl group-containing unsaturated monomer (B) and at least one monomer (C) selected from the group consisting of methyl methacrylate, vinyl acetate and diethylacrylamide, as essential raw-material monomers.

It is preferable that the solvent-insoluble content in the acrylic emulsion polymer be not less than 70 wt %.

It is preferable that the solvent-insoluble content in the acrylic adhesive layer be not less than 90 wt % and that the breaking elongation of the acrylic adhesive layer at 23° C. be not more than 130%.

It is preferable that the molar number of functional groups capable of reacting with a carboxyl group of the water-insoluble crosslinking agent per one mole of carboxyl groups of the carboxyl group-containing unsaturated monomer (B) in the water dispersible acrylic adhesive composition be 0.4 moles to 1.3 moles.

The content of alkyl (meth)acrylate (A) is preferably 70 wt % to 99 wt %, the content of the carboxyl group-containing unsaturated monomer (B) is preferably 0.5 wt % to 10 wt % and the content of the monomer (C) is preferably 0.5 wt % to 10 wt %, based on the total amount of the raw-material monomers constituting the acrylic emulsion polymer.

The present invention further provides an optical component to which the surface protective film is laminated.

### Advantageous Effects of Invention

The surface protective film of the present invention, since it has the above constitution, is excellent in scratch resistance, whitening resistance and removability. In addition, whitening is also suppressed (whitening by moisture absorption) during storage while humidifying. Because of this, when the appearance of an object is inspected with the surface protective film laminated thereto, inspection can be performed highly accurately.

### BRIEF DESCRIPTION OF DRAWINGS

FIG. 1 is a schematic sectional view showing a use pattern a surface protective film.

FIG. 2 is a schematic sectional view showing a surface protective film before use.

FIG. 3 is a schematic sectional view showing how to remove a surface protective film.

FIG. 4 is an illustrative drawing showing how to measure back-face peeling strength.

### DESCRIPTION OF EMBODIMENTS

Now, the surface protective film of the present invention will be described by way of a preferred embodiment of the present invention. Note that, in the following figures, same reference numerals are used to designate members and sites having same functions and duplicated explanation may be omitted or simplified. Furthermore, the embodiment is schematically shown in each figure in order to clearly describe the present invention and thus the figure does not represent the surface protective film of the present invention actually provided as a product, accurately in size and scale.

In the specification, the term “lubricant” refers to a component capable of exerting a function of improving the lubricating property of the topcoat layer by adding it to the topcoat layer. Improvement of the lubricating property of a topcoat can be determined, for example, by a reduction of the friction coefficient of the topcoat layer. The term “binder” in the topcoat layer refers to a basic component contributing to film formation of the topcoat layer. The term “polyester resin” refers to a resin containing a polyester (refers to a polymer having a main chain formed by ester linkage between monomers) as a main component (a component preferably contained in an amount of more than 50 wt %). The term “acrylic adhesive (acrylic pressure-sensitive adhesive)” refers to an adhesive (pressure-sensitive adhesive) containing an acrylic polymer as a base polymer (main component of a polymer contained in the acrylic adhesive; a component preferably contained in an amount of more than 50 wt %) The term “acrylic polymer” refers to a polymer containing a monomer having at least one (meth)acryloyl group in a molecule (hereinafter, the monomer is sometimes referred to as an “acrylic monomer”) as a main constitutional monomer component (main component of a monomer, preferably a component occupying not less than 50 wt % based on the total amount of monomers constituting the acrylic polymer). The “(meth)acryloyl group” is the term inclusively referring to an acryloyl group and a methacryloyl group. Similarly, the “(meth)acrylate” is the term inclusively referring to an acrylate and a methacrylate. In the specification, the “alkylene oxide chain” is the term inclusively referring to an oxyalkylene unit (—OR—) and a portion consisting of not less than two continuous oxyalkylene units (i.e., structural part represented by —(OR)n- where n≧2, and also figured out as a polyalkylene oxide chain).

<Structure and Use Pattern of Surface Protective Film>

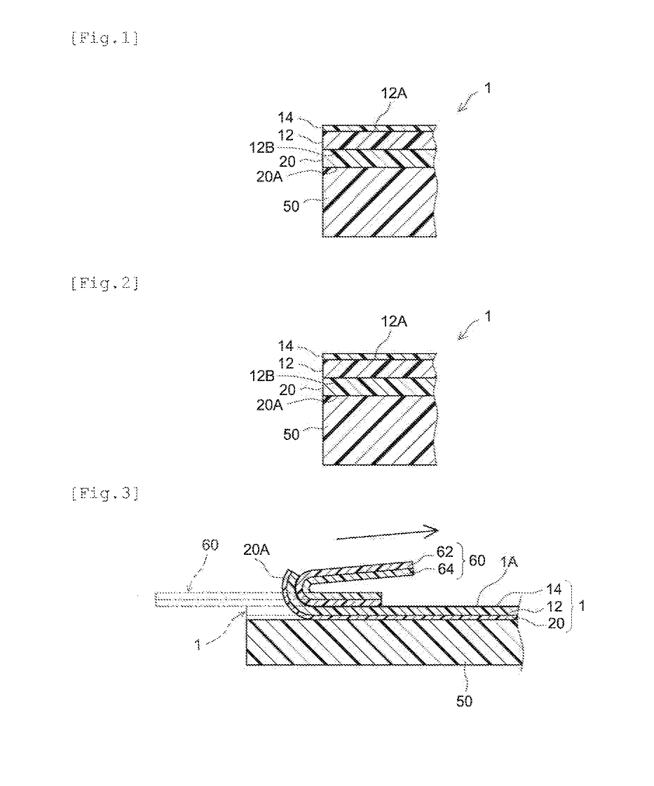

A structure and a use pattern of the surface protective film of the present invention are shown in FIG. 1. A surface protective film 1 has a substrate 12 having a first face 12A and a second face 12B, a topcoat layer 14 formed on the first face (back face) 12A and an adhesive layer 20 (acrylic adhesive layer 20) formed on the second face (front face) 12B. The substrate 12 is preferably a transparent resin film (for example, polyester resin film). Also, the topcoat layer 14 is preferably formed directly (without interposing another layer between them) on the first face 12A, as shown in FIG. 1. The adhesive layer 20 is preferably formed continuously; however, how to form the adhesive layer 20 is not limited to this. The adhesive layer 20 may be formed, for example, into a regular pattern or a random pattern consisting of dots, stripes and the like. The surface protective film 1 is used by laminating the surface 20A (adhesive face, i.e., adhesive face to an object) of the adhesive layer 20 to the surface of an object 50 (adherend 50) (object to be protected, for example, an optical part such as a polarizing plate). The surface protective film 1 before use (in other words, before lamination to an object) may be configured such that the surface 20A of the adhesive layer 20 is protected by a release liner 30, preferably as shown in FIG. 2. The release liner 30 is constituted such that at least the face of the liner facing the adhesive layer 20 is a release face.

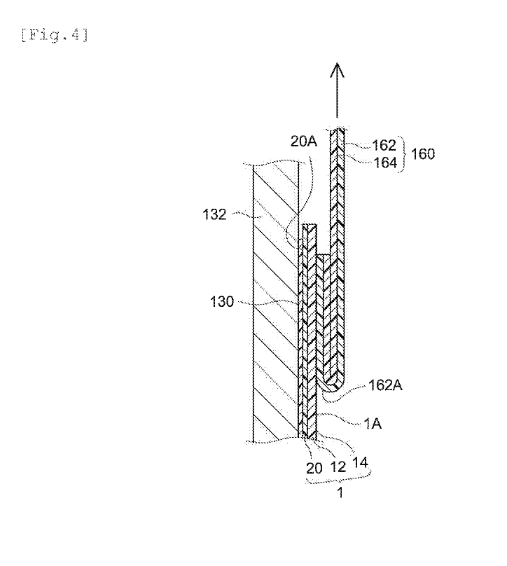

The surface protective film 1, which completed its role of protecting the object 50 and is no longer required, is peeled off and removed from the surface of the object 50. An operation of removing the surface protective film 1 from the surface of the object 50 is made, for example, as shown in FIG. 3, preferably in a manner including an operation of laminating an adhesive tape 60 to the back face 1A (the surface of topcoat layer 14) of the surface protective film 1 and picking up at least part (preferably, at least part of the outer edge) of the surface protective film 1 together with the adhesive tape 60 (pickup tape) from the surface of the object 50. Likewise, the removal of the surface protective film 1 from the object 50 can be started by pulling the pickup tape 60 laminated to the back face 1A of the surface protective film 1, taking advantage of adhesive force of the pickup tape 60 to the back face 1A. According to this aspect, an operation of removing the surface protective film 1 from the object 50 can be efficiently carried out. For example, the pickup tape 60 is laminated to the back face 1A of the surface protective film 1, such that one of the ends protrudes from the outer edge of the surface protective film 1, as shown by an imaginary line in FIG. 3. Then, as shown by a solid line in FIG. 3, the surface protective film 1 is better to be pulled so as to be folded back (rolled up) inwardly from the outer edge by grabbing the end of the pickup tape 60. Note that, as shown in FIG. 3, after the outer edge of the surface protective film 1 is removed from the object 50, the remaining portion of the surface protective film 1 may be removed from the object 50 by an operation of continuously pulling the pickup tape 60 or by directly grabbing the portion of the surface protective film 1 already removed from the object 50 and pulling it.

<Substrate>

The substrate of the surface protective film of the present invention is not particularly limited; however, a resin film is preferred. Such a resin film is preferably one of the films formed of various types of resin materials. The resin material is preferably a resin material capable of constituting a resin film excellent in one or not less than two properties selected from e.g., transparency, mechanical strength, thermostability, moisture shielding characteristics and isotropic nature. For example, a transparent resin film (including transparent colored resin film constituted of a resin material containing polyesters such as polyethylene terephthalate (PET), polyethylene naphthalate (PEN) and polybutylene terephthalate; celluloses such as diacetyl cellulose and triacetyl cellulose; polycarbonates; acrylic polymers such as poly(methyl methacrylate) or the like, as a main component (component preferably contained in an amount of more than 50 wt %), is preferably mentioned. Examples of other resin materials constituting the above resin film include resin materials containing styrenes such as polystyrene and an acrylonitrile-styrene copolymer; olefins such as polyethylene, polypropylene, a polyolefin having a cyclic or a norbornene structure and an ethylene-propylene copolymer; polyvinyl chlorides; and polyamides such as nylon 6, nylon 6, 6, and an aromatic polyamide, as a main component. Further examples thereof include resin materials containing polyimides, polysulfones, polyethersulfones, polyether ether ketones, polyphenylene sulfides, polyvinyl alcohols, poly(vinylidene chlorides), poly (vinyl butyrals), polyarylates, polyoxymethylenes and epoxies, as a main component. Note that the resin materials constituting the resin film can be used alone or in combination with not less than two.

The resin film serving as the substrate is preferably transparent and optically less anisotropic (e.g., phase difference). Generally, the less optically anisotropic, the more preferable. Particularly, in the resin film to be used as a substrate of a surface protective film for optical parts, it is significantly useful for the resin film to be as less optically anisotropic as possible. The resin film may have a single-layer structure or a laminate structure formed of a plurality of layers different in composition. Generally, a resin film of a single-layer structure is preferred.

The refractive index of the resin film is not particularly limited; however, the refractive index preferably falls within the range of 1.43 to 1.6 and more preferably 1.45 to 1.5, in view of appearance characteristics. As the value of the refractive index, a notary value provided by a manufacturer can be employed. If the notary value is not provided, a measurement value obtained by a method according to JIS K 7142 A can be employed. The whole light transmittance in a visible light wavelength region of the resin film is not particularly limited; however, the whole light transmittance is preferably not less than 70% (for example, 70% to 99%), more preferably not less than 80% (for example, 80% to 99%) and further preferably not less than 85% (for example, 85% to 99%) in view of transparency. As the whole light transmittance value, a notary value provided by a manufacturer can be employed. If the notary value is not provided, a measurement value obtained in accordance with JIS K 7361-1 can be employed.

In the surface protective film of the present invention, the substrate is preferably a resin film (polyester resin film) formed of a resin (polyester resin) containing a polyester as a main component (component preferably contained in an amount of more than 50 wt %), and particularly preferably a resin film (PET film) of a polyester mainly containing PET and a resin film (PEN film) of a polyester mainly containing PEN.

A resin material constituting the substrate may contain, if necessary, various types of additives such as an antioxidant, a UV absorber, an antistatic component, a plasticizer and a coloring agent (pigment, dye, etc.). To the first face (back face, i.e., surface on which a topcoat layer is to be provided) of the substrate, for example, a surface treatment commonly or routinely provided in the art, such as a corona discharge treatment, a plasma treatment, a UV irradiation treatment, an acid treatment, an alkali treatment and a coating treatment with an anchor coat, may be applied. Such a surface treatment is preferably a treatment, for example, for enhancing adhesion between the substrate back-face and the topcoat layer. Furthermore, a surface treatment of introducing a polar group such as a hydroxyl group (—OH group) into the substrate back-face is preferred. In addition, in the surface protective film of the present invention, the same surface treatment applied to the back face may be applied to the second face (front face, i.e., the surface on which an adhesive layer is to be formed) of the substrate. Such a surface treatment is preferably a treatment for enhancing adhesion (anchor effect of the adhesive layer) between the substrate (support) and the adhesive layer.

The thickness of the substrate can be appropriately selected in consideration of e.g., use, purpose, and use pattern of a surface protective film. The thickness of the substrate is preferably 10 μm to 200 μm, more preferably 15 μm to 100 μm and further preferably 20 μm to 70 μm, in consideration of balance between e.g., strength and workability such as handling and cost and appearance inspection.

<Binder>

The surface protective film of the present invention has a topcoat layer on the back face (first face) of a substrate. The topcoat layer contains a polyester resin serving as a binder and a wax serving as a lubricant. The polyester resin is a resin material containing a polyester as a main component (component occupying preferably not less than 50 wt %, more preferably not less than 75 wt % and further preferably not less than 90 wt %). The polyester is constituted by condensation of one or not less than two types of compounds (polyvalent carboxylic acid component) selected from the polyvalent carboxylic acids (preferably dicarboxylic acids) having not less than two carboxyl groups in a molecule and derivatives thereof (e.g., anhydrides, esters and halides of the polyvalent carboxylic acids) and one or not less than two types of compounds (polyhydric alcohol component) selected from polyhydric alcohols having not less than two hydroxyl groups (preferably diols) in a molecule.

Examples of the compound corresponding to the polyvalent carboxylic acid component include, but not particularly limited to, aliphatic dicarboxylic acids such as oxalic acid, malonic acid, difluoromalonic acid, alkylmalonic acid, succinic acid, tetrafluorosuccic acid, alkylsuccinic acid, (±)-malic acid, meso-tartaric acid, itaconic acid, maleic acid, methylmaleic acid, fumaric acid, methylfumaric acid, acetylenedicarboxylic acid, glutaric acid, hexafluoroglutaric acid, methylglutaric acid, glutaconic acid, adipic acid, dithioadipic acid, methyladipic acid, dimethyladipic acid, tetramethyladipic acid, methyleneadipic acid, muconic acid, galactaric acid, pimelic acid, suberic acid, perfluorosuberic acid, 3,3,6,6-tetramethylsuberic acid, azelaic acid, sebacic acid, perfluorosebacic acid, brasylic acid, dodecyldicarboxylic acid, tridecyldicarboxylic acid, and tetradecyldicarboxylic acid; alicyclic dicarboxylic acids such as cycloalkyl dicarboxylic acid (e.g., 1,4-cyciohexanedicarboxylic acid, 1,2-cyclohexanedicarboxylic acid), 1,4-(2-norbornene)dicarboxylic acid, 5-norbornene-2,3-dicarboxylic acid (himic acid), adamantanedicarboxylic acid and spiroheptane dicarboxylic acid; aromatic dicarboxylic acids such as phthalic acid, isophthalic acid, dithioisophthalic acid, methylisophthalic acid, dimethylisophthalic acid, chlorcoisophthalic acid, dichloroisophthalic acid, terephthalic acid, methyiterephthalic acid, dimrethylterephthalic acid, chloroterephthalic acid, bromoterephthalic acid, naphthalenedicarboxylic acid, oxofluorenedicarboxylic acid, anthracenedicarboxylic acid, biphenyldicarboxylic acid, biphenylenedicarboxylic acid, dimethyl biphenylenedicarboxylic acid, 4,4″-p-telephenylenedicarboxylic acid, 4,4″-p-quallelphenyldicarboxylic acid, bibenzyldicarboxylic acid, azobenzenedicarboxylic acid, homophthalic acid, phenylene diacetic acid, phenylenedipropionic acid, naphthalenedicarboxylic acid, naphthalenedipropionic acid, biphenyidiacetic acid, biphenyldipropionic acid, 3,3′-[4,4′-(methylenedi-p-biphenylene)dipropionic acid, 4,4′-bibenzyldiacetic acid, 3,3′ (4,4′-bibenzyl)dipropionic acid and oxydi-p-phenylenediacetic acid; acid anhydrides of the above polyvalent carboxylic acids; esters of the above polyvalent carboxylic acids (for example, alkyl esters, monoesters and diesters may be mentioned); and acid halides corresponding to the above polyvalent carboxylic acids (for example, dicarboxylic acid chloride).

Of them, as the compounds corresponding to the polyvalent carboxylic acid components, aromatic dicarboxylic acids such as terephthalic acid, isophthalic acid, and naphthalene dicarboxylic acid and acid anhydrides thereof; aliphatic dicarboxylic acids such as adipic acid, sebacic acid, azelaic acid, succinic acid, fumaric acid, maleic acid, himic acid, and 1,4-cyclohexanedicarboxylic acid and acid anhydrides thereof; and lower alkyl esters of the aforementioned dicarboxylic acids (for example, esters with monoalcohols having 1 to 3 carbon atoms) or the like are more preferred.

Examples of the compounds corresponding to the polyhydric alcohol components include, but not particularly limited to, diols such as ethylene glycol, propylene glycol, 1,2-propanediol, 1,3-propanediol, 1,3-butanediol, 1,4-butanediol, neopentyl glycol, 1,5-pentane diol, 1,6-hexane diol, 3-methylpentane diol, diethylene glycol, 1,4-cyclohexanedimethanol, 3-methyl-1,5-pentane diol, 2-methyl-1,3-propanediol, 2,2-diethyl-1,3-propane diol, 2-butyl-2-ethyl-1,3-propane diol, xylylene glycol, hydrogenated bisphenol A, and bisphenol A. Other than these, alkylene oxide adducts of these compounds (for example, ethylene oxide adducts and propyleneoxide adducts) are mentioned.

Particularly, the polyester resins preferably include water dispersible polyesters. In other words, a water dispersible polyester is preferably contained as a main component. Examples of such a water dispersible polyester include polyesters enhanced in water dispersibility by introducing, into a polymer, a hydrophilic functional group (for example, one or not less than two types of hydrophilic functional groups such as a metal sulfonate group, a carboxyl group, an ether group and a phosphate group). As a method of introducing a hydrophilic functional group into a polymer, methods commonly known in the art such as a copolymerization method of a compound having a hydrophilic functional group and a modification method of a polyester or its precursor (for example, polyvalent carboxylic acid component, polyhydric alcohol component, and oligomers of them) to produce a hydrophilic functional group, are mentioned. As a preferable water dispersible polyester, a polyester (copolyester) obtained by copolymerization of a compound having a hydrophilic functional group, is mentioned.

In the surface protective film of the present invention, the polyester resin to be used as a binder for a topcoat layer is not particularly limited; however, a polyester resin having a saturated polyester as a main component may be used or a polyester resin having an unsaturated polyester as a main component may be also used. Of them, as the polyester resin to be used as a binder of the topcoat layer, a polyester resin having a saturated polyester as a main component is preferred. Particularly, a polyester resin containing a saturated polyester (for example, a saturated copolyester), to which water dispersibility is imparted, as a main component, is more preferred.

Such a polyester resin (including a polyester resin prepared in a form of a water dispersion solution) can be synthesized by a method commonly known in the art or can be easily obtained as a commercially available product.

The molecular weight of the polyester resin is not particularly limited; however the standard polystyrene-equivalent weight average molecular weight (Mw) of the polyester resin measured by gel permeation chromatography (GPC) is preferably 0.5×10⁴ to 15×10⁴ (preferably 1×10⁴ to 6×10⁴). The glass-transition temperature (Tg) of the polyester resin is not particularly limited; however, Tg is preferably 0° C. to 120° C. and more preferably 10° C. to 80° C.

The topcoat layer may further contain a resin other than a polyester resin (one or not less than two types of resins selected from, for example, an acrylic resin, an acryl-urethane resin, an acryl-styrene resin, an acryl-silicone resin, a silicone resin, a polysilazane resin, a polyurethane resin, a fluororesin and a polyolefin resin) as a binder as long as the performance of the surface protective film of the present invention (performance such as transparency, scratch resistance and whitening resistance) is not damaged. Particularly, in the surface protective film of the present invention, the binder of the topcoat layer is preferably formed substantially of a polyester resin alone. For example, a topcoat layer containing a polyester resin in a ratio of 98 wt % to 100 wt % relative to the binder is preferred. The ratio of the binder in the entire topcoat layer is not particularly limited; however, the ratio is preferably 50 wt % to 95 wt % and more preferably 60 wt % to 90 wt %.

<Lubricant>

The topcoat layer in the surface protective film of the present invention contains an ester of a higher fatty acid and a higher alcohol (hereinafter referred to also as a “wax ester”) as a lubricant. The “higher fatty acid” herein refers to a carboxylic acid (particularly, monovalent carboxylic acid) having carbon atoms of not less than 8 (preferably not less than 10, more preferably not less than 10 and not more than 40). Whereas, the “higher alcohol” refers to an alcohol (particularly monovalent or bivalent alcohol, more preferably monovalent alcohol) having carbon atoms of not less than 6 (preferably not less than 10, more preferably not less than 10 and not more than 40). The topcoat layer formed of a composition containing such a wax ester and the binder (polyester resin) in combination, is rarely whitened even if the layer is kept in high-temperature and high-humidity conditions. Therefore, the surface protective film of the present invention having a substrate having such a topcoat layer has higher appearance quality.

In the surface protective film of the present invention, the reason why more excellent whitening resistance (rarely whitened even if it is kept, for example, in high-temperature and high-humidity conditions) can be realized by the topcoat layer having the aforementioned constitution, is not clearly; however, the following reason is presumable. It is presumed that silicone lubricants used in the art bleed out in the surface of a topcoat layer, thereby exerting a function of imparting the lubricating property to the surface. However, the degree of bleeding of these silicone lubricants is easily varied by difference in storage conditions (temperature, humidity, time, etc.). Because of this, if the amount of silicone lubricant used is set so as to obtain appropriate lubricating property for relatively a long period (for example, about three months) immediately after production of a surface protective film, in the case where it is kept, for example, in general storage conditions (for example, 25° C., 50% RH), bleeding of the lubricant excessively proceeds in the case where the surface protective film is stored in high-temperature and high-humidity conditions (for example, 60° C., 95% RH) for two weeks. The silicone lubricant that excessively bleeds out in this way whitens the topcoat layer (further whitens the surface protective film).

In the surface protective film of the present invention, a predetermined combination of a wax ester serving as a lubricant and a polyester resin serving as a binder of the topcoat layer is employed. According to the combination of such a lubricant and a binder, the degree of bleeding of the wax ester from the topcoat layer is rarely influenced by storage conditions. It can be considered that for this reason, the whitening resistance of the surface protective film is improved.

The wax ester is not particularly limited; however, the wax ester is preferably a compound represented by the following formula (W). The wax ester may contain one or not less than two types of compounds represented by the following formula (W):

X—COO—Y (W)

wherein X and Y each independently represent a hydrocarbon group having carbon atoms of 10 to 40 (preferably 10 to 35, more preferably 14 to 35 and further preferably 20 to 32). If the number of carbon atoms is excessively low, the effect of imparting a lubricating property to the topcoat layer sometimes tends to be insufficient. The hydrocarbon group may be saturated or unsaturated; however, the hydrocarbon group is preferably a saturated hydrocarbon group. The hydrocarbon group may have a structure containing an aromatic ring or a structure (aliphatic hydrocarbon group) containing no aromatic ring. Alternatively, the hydrocarbon group may have a structure (alicyclic hydrocarbon group) containing an aliphatic ring or may be a chain-form (including linear and branched structure) hydrocarbon group.

As the wax ester, a compound represented by the formula (W) where X and Y each independently represent a chain-form alkyl group (more preferably, a linear alkyl group) having 10 to 40 carbon atoms is preferred. Specific examples of such a compound include myricyl cerotate (CH₃(CH₂)₂₄COO(CH₂)₂₉CH₃), myricyl palmitate (CH₃(CH₂)₁₄COO(CH₂)₂₉CH₃), cetyl palmitate (CH₃(CH₂)₁₄COO(CH₂)₁₅CH₃) and stearyl stearate (CH₃(CH₂)₁₆COO(CH₂)₁₇CH₃).

The melting point of the wax ester is not particularly limited; however, the melting point is preferably not less than 50° C., more preferably not less than 60° C., further preferably not less than 70° C., and further more preferably not less than 75° C. According to such a wax ester, a higher whitening resistance can be obtained. The wax ester preferably has a melting point of not more than 100° C. Such a wax ester, since it is highly effective in imparting a lubricating property, can form a topcoat layer having a higher scratch resistance. If the melting point of the wax ester is not more than 100° C., it is preferable since a water dispersion solution of the wax ester is easily prepared. For example, myricyl cerotate is preferably mentioned.

Examples of the raw material for the topcoat layer include, but not particularly limited to, natural waxes containing the aforementioned wax ester. As the natural waxes, waxes having a wax ester content (if not less than two types of wax esters are contained, the total content of them) of not less than 50 wt % (preferably not less than 65 wt % and further preferably not less than 75 wt %) on the basis of the nonvolatile content (NV) are preferred. For example, natural waxes such as vegetable waxes including carnauba wax (generally, containing myricyl cerotate in a ratio of not less than 60 wt %, preferably not less than 70 wt % and more preferably not less than 80 wt %) and palm wax; and animal waxes such as bees wax and whale wax, can be used. The melting point of the natural wax to be used is not particularly limited; however, the melting point is preferably not less than 50° C. (more preferably not less than 60° C., further preferably not less than 70° C. and further more preferably not less than 75° C.). Furthermore, the raw material for the topcoat layer may be a wax ester chemically synthesized or a natural wax increased in purity of the wax ester by purification. These raw materials can be used alone or in combination with not less than two types.

The ratio of a lubricant occupied in the entire topcoat layer, is not particularly limited; however, the ratio is preferably 5 wt % to 50 wt % and more preferably 10 wt % to 40 wt %. If the content of a lubricant is not less than 5 wt %, it is preferable since satisfactory scratch resistance can be easily obtained. In contrast, if the content of a lubricant is not more than 50 wt %, it is preferable since an effect of improving whitening resistance can be easily obtained.

In the surface protective film of the present invention, the topcoat layer may contain another lubricant in addition to the wax ester as long as the effect is not impaired. Examples of such another lubricant include, but not particularly limited to, various types of waxes such as petroleum waxes (paraffin wax, etc.), mineral waxes (montane wax, etc.), higher fatty acids (cerotic acid, etc.) and neutral fats (palmitic triglyceride, etc.). Furthermore, the topcoat layer may supplementarily contain e.g., a general silicone lubricant and a fluorine lubricant in addition to the wax ester. In the surface protective film of the present invention, it is preferable that such a silicone lubricant and a fluorine lubricant or the like be not substantially contained (the total content of these based on the entire topcoat layer is not more than 0.01 wt % or not more than detection limit). Note that a silicone compound to be used for a different purpose from that of a lubricant (for example, as a defoaming agent described later of a coating material for forming a topcoat) may be contained.

The topcoat layer in the surface protective film of the present invention may contain, if necessary, additives such as an antistatic component, a crosslinking agent, an antioxidant, a coloring agent (pigment, dye, etc.), a fluidity moderator (thixotropy agent, thickener, etc.), a film-forming auxiliary agent, a surfactant (defoaming agent, a dispersing agent, etc.) and an antiseptic agent.

<Antistatic Component of Topcoat Layer>

In the surface protective film of the present invention, it is preferable that the topcoat layer contain an antistatic component. If the surface protective film of the present invention has excellent antistatic property, the surface protective film can be preferably used, for example, in processing and transportation steps for antistatic-phobic products such as liquid crystal cells and semiconductor devices.

The antistatic component is a component capable of exerting a function of preventing or suppressing charging of the surface protective film. In the case where the antistatic component is contained in the topcoat layer, such the antistatic component is not particularly limited; however, for example, organic or inorganic conductive substances and various types of antistatic agents are mentioned.

Examples of the organic conductive substance include, but not particularly limited to, cationic antistatic agents having a quaternary ammonium salt, a pyridinium salt or a cationic functional group such as a first amino group, the second amino group and the third amino group; anionic antistatic agents having an anionic functional group such as sulfonate and a sulfate, a phosphonate and a phosphate; amphoteric ion antistatic agents such as an alkyl betaine and a derivative thereof, an imidazoline and a derivative thereof and an alanine and a derivative thereof; nonionic antistatic agents such as an amino alcohol and a derivative thereof, glycerin and a derivative thereof and a polyethylene glycol and a derivative thereof; ion conductive polymers obtained by polymerizing or copolymerizing a monomer(s) having a cationic, an anionic, and/or an amphoteric ion conductive group (for example, quaternary ammonium salt group) as mentioned above; and conductive polymers such as polythiophene, polyaniline, polypyrrole, polyethyleneimine and arylamine polymer. Such antistatic agents can be used alone or in combination with not less than two types.

Furthermore, examples of the inorganic conductive substance include, but not particularly limited to, tin oxide, antimony oxide, indium oxide, cadmium oxide, titanium oxide, zinc oxide, indium, tin, antimony, gold, silver, copper, aluminium, nickel, chromium, titanium, iron, cobalt, copper iodide, ITO (indium oxide/tin oxide) and ATO (antimony oxide/tin oxide). Note that such inorganic conductive substances can be used alone or in combination with not less than two types.

Examples of the antistatic agent include, but not particularly limited to, a cationic antistatic agent, an anionic antistatic agent, an amphoteric ion antistatic agent, a nonionic antistatic agent, and ion conductive polymers obtained by polymerizing or copolymerizing a monomer(s) having an ion conductive group such as a cationic, an anionic and an amphoteric ion conductive group as mentioned above.

In the surface protective film of the present invention, the antistatic component to be used in the topcoat layer preferably contains an organic conductive substance. The organic conductive substance is not particularly limited; however, various types of conductive polymers can be preferably mentioned in consideration of balance between a satisfactory antistatic property and a high scratch resistance. The conductive polymers are not particularly limited; however, e.g., polythiophene, polyaniline, polypyrrole, polyethyleneimine and arylamine polymers are preferably mentioned. Such conductive polymers can be used alone or in combination with not less than two types. Furthermore, organic conductive substances such as conductive polymers as mentioned above may be used in combination with another antistatic component (inorganic conductive substance, antistatic agent, etc.). The amount of conductive polymer used is not particularly limited; however, the amount is preferably 10 parts by weight to 200 parts by weight relative to 100 parts by weight of the binder contained in the topcoat layer, more preferably 25 parts by weight to 150 parts by weight and further preferably 40 parts by weight to 120 parts by weight. If the amount of conductive polymer used is not less than 10 parts by weight, it is preferable since a satisfactory antistatic effect is easily obtained. In contrast, if the amount is not more than 150 parts by weight, it is preferable since compatibility of the conductive polymer in the topcoat layer is sufficiently obtained, with the result that satisfactory appearance quality and satisfactory solvent resistance of the topcoat layer are easily obtained.

In the surface protective film of the present invention, preferable examples of the conductive polymer include a polythiophene and a polyaniline. As the polythiophene, a polythiophene having a polystyrene-equivalent weight average molecular weight (hereinafter referred to as “Mw”) of not more than 40×10⁴ (more preferably, not more than 30×10⁴) is preferable. As the polyaniline, a polyaniline having a Mw of not more than 50×10⁴ (more preferably, not more than 30×10⁴) is preferable. The Mw of these conductive polymers is preferably not less than 0.1×10⁴ (more preferably, not less than 0.5×10⁴). Note that “polythiophene” in the specification refers to an unsubstituted or substituted thiophene polymer. Particularly, as the substituted thiophene polymer, a poly(3,4-ethylenedioxythioxythiophene) is preferable.

If a method including applying a coating material for forming the topcoat layer onto a substrate and drying or hardening the coating material is employed as a method for forming the topcoat layer, the conductive polymer to be used for preparation of the coating material is preferably dissolved or dispersed in water (an aqueous conductive polymer solution). Such an aqueous conductive polymer solution is prepared by dissolving or dispersing, for example, a conductive polymer having a hydrophilic functional group (synthesized by a copolymerization method with a monomer having a hydrophilic functional group in a molecule, or the like) in water. Examples of the hydrophilic functional group include a sulfo group, an amino group, an amide group, an imino group, a hydroxyl group, a mercapto group, a hydrazino group, a carboxyl group, a quaternary ammonium group, a sulfate group (—O—SO₃H) and a phosphate group (for example —O—PO (OH)₂). These hydrophilic functional groups may form salts. As a commercially available product of an aqueous polythiophene solution, “Denatron” series (trade name) manufactured by Nagase ChemteX Corporation is mentioned. As a commercially available product of an aqueous polyaniline sulfonic acid solution, an “aqua-PASS” (trade name) manufactured by Mitsubishi Rayon Co., Ltd., is mentioned.

In the surface protective film of the present invention, it is preferable to use an aqueous polythiophene solution for preparing the coating material, and more preferable to use an aqueous solution of a polythiophene containing polystyrene sulfonate (PSS) (PSS may be added as a dopant to a polythiophene). Such an aqueous solution may contain polythiophene: PSS in a mass ratio of 1:1 to 1:10. The total content of polythiophene and PSS in the aqueous solution is not particularly limited; however, the total content is preferably 1 wt % to 5 wt %. As a commercially available product of such an aqueous polythiophene solution, “Baytron” (trade name) manufactured by H. C. Stark, is mentioned.

Note that if an aqueous polythiophene solution containing PSS is used, the total amount of polythiophene and PSS is not particularly limited, as described above; however, the total amount is preferably 5 parts by weight to 200 parts by weight relative to the binder (100 parts by weight), more preferably 10 parts by weight to 100 parts by weight and further preferably 25 parts by weight to 70 parts by weight.

The topcoat layer, if necessary, may contain a conductive polymer in combination with one or not less than two types of other antistatic components (such as organic conductive substance, inorganic conductive substance and antistatic agent other than the conductive polymer). In the surface protective film of the present invention, it is particularly preferable that the topcoat layer does not substantially contain an antistatic component other than the conductive polymer. In other words, it is particularly preferable that the antistatic component to be contained in the topcoat layer is substantially a conductive polymer alone.

<Crosslinking Agent>

In the surface protective film of the present invention, it is preferable that the topcoat layer contain a crosslinking agent. Examples of such a crosslinking agent include, but not particularly limited to, a melamine crosslinking agent, an isocyanate crosslinking agent and an epoxy crosslinking agent. Note that the crosslinking agents can be used alone or in combination with not less than two types. According to such a crosslinking agent, at least one of the effects such as scratch resistance, solvent resistance, printing adhesion and a reduction in a friction coefficient (in other words, improvement of a lubricating property), can be improved. Particularly, the crosslinking agent is preferably a melamine crosslinking agent. The topcoat layer may be a layer substantially containing a melamine crosslinking agent alone as a crosslinking agent; in other words, may be a layer which does not substantially contain a crosslinking agent other than a melamine crosslinking agent.

<Formation of Topcoat Layer>

A method for forming the topcoat layer is not particularly limited. The topcoat layer is preferably formed by a method including applying a liquid-state composition (coating composition for forming a topcoat layer) prepared by dispersing or dissolving the resin component and additives to be used as necessary in an appropriate solvent, to a substrate. For example, as a method for forming the topcoat layer, a method including applying the coating composition to a first face of a substrate and drying it, and if necessary, applying a hardening treatment (such as heat treatment, and UV treatment), is preferably mentioned. The NV of the coating composition is not particularly limited; however, the NV is preferably not more than 5 wt % (for example, 0.05 wt % to 5 wt %) and more preferably not more than 1 wt % (for example, 0.10 wt % to 1 wt %). When a thin topcoat layer is formed, it is preferable that NV of the coating composition be controlled to be preferably 0.05 wt % to 0.50 wt % (particularly 0.10 wt % to 0.30 wt %). Owing to use of a low NV coating composition, a more uniform topcoat layer can be formed.

As a solvent constituting a coating composition for forming the topcoat layer, a solvent capable of stably dissolving or dispersing the topcoat layer-forming components is preferred. Such a solvent may be an organic solvent, water or a solvent mixture of these. Examples of the organic solvent include esters such as ethyl acetate; ketones such as methyl ethyl ketone, acetone and cyclohezanone;

cyclic ethers such as tetrahydrofuran (THF) and dioxane; aliphatic or alicyclic hydrocarbons such as n-hexane and cyclohexane; aromatic hydrocarbons such as toluene and xylene; aliphatic or alicyclic alcohols such as methanol, ethanol, n-propanol, isopropanol and cyclohexanol; and glycol ethers such as an alkylene glycol monoalkyl ether (for example, ethylene glycol monomethyl ether, ethylene glycol monoethyl ether) and a dialkylene glycol monoalkyl ether. The organic solvents can be used alone or in combination with not less than two types. Of them, as a solvent for constituting the coating composition for forming the topcoat layer, water or a solvent mixture containing water (for example, a solvent mixture of water and ethanol) as a main component, is preferably mentioned.

<Characteristics of Topcoat Layer>

In the surface protective film of the present invention, the thickness of the topcoat layer is not particularly limited; however, the thickness is preferably 3 nm to 500 nm, more preferably 4 nm to 100 am and further preferably 5 r m to 60 nm. If the thickness of the topcoat layer is not more than 500 nm, it is preferable since satisfactory transparency (light transmissibility) of the surface protective film is easily obtained. In contrast, if the thickness is not less than 3 nm, it is preferable since the uniform topcoat layer is easily formed (for example, local, variation in thickness of the topcoat layer reduces), with the result that variation of appearance of the surface protective film rarely occurs.

Particularly, in the surface protective film of the present invention, the thickness of the topcoat layer is not particularly limited; however, to obtain a surface protective film having excellent appearance quality, the thickness is preferably not less than 3 nm and less than 50 nm, more preferably not less than 3 nm and less than 30 nm, further preferably not less than 4 nm and less than 20 nm and most preferably not less than 5 nm and less than 11 nm. If the surface protective film has an excellent appearance quality, appearance inspection of a product (an object) through the surface protective film can be accurately performed. The topcoat layer is preferably thin since the effect of the topcoat layer on the characteristics of the substrate (optical characteristics, dimensional stability, etc.) would be low.

The thickness of the topcoat layer can be determined by observing a section of the topcoat layer by a transmission electron microscope (TEM). For example, a target sample (a substrate having a topcoat layer formed thereon, a surface protective film having the substrate, etc.) is stained with a heavy metal in order to clearly distinguish the topcoat layer, embedded in a resin and sectioned by an ultrathin sectioning method. The obtained sample section is observed by a TEM to determine the thickness. As the TEM, for example, TEM “H-7650” Type, manufactured by Hitachi, Ltd. is mentioned. In Examples described later, a section image which is obtained in the conditions of an acceleration voltage of 100 kV and a magnification of 60,000 is subjected to a binarization processing. Thereafter, the cross-sectional area of the topcoat is divided by a sample length within the field of vision to obtain the real thickness of the topcoat layer (average thickness within the field of vision).

Note that if the topcoat layer can be sufficiently clearly observed even if staining with a heavy metal is not performed, the staining treatment with a heavy metal may be omitted. Alternatively, a calibration curve showing the correlation between the thickness determined by a TEM and each of detection results obtained by various thickness determination apparatuses (for example, a surface roughness meter, an interference thickness meter, an infrared spectrometer, various types of X-ray diffractometers, etc.) may be prepared and then calculation is made to obtain the thickness of the topcoat layer.

In the surface protective film of the present invention, the surface resistivity of the topcoat layer is not particularly limited; however, the surface resistivity is preferably not more than 10¹²Ω, and more preferably 10⁶Ω to 10¹²Ω. The surface protective film exhibiting such a surface resistivity is preferably used as the surface protective film used, for example, in the steps of processing or transporting an antistatic-phobic product such as liquid crystal cells and semiconductor devices. Particularly, the surface protective film having a surface resistivity of not more than 10¹¹Ω (preferably 5×10⁶Ω to 10¹⁰Ω and more preferably 10⁷Ω to 10⁹Ω) is more preferable. The value of the surface resistivity can be calculated from the surface resistance value measured by a commercially available dielectric resistance measurement apparatus under an atmosphere of 23° C. and 50% RH.

In the surface protective film of the present invention, the friction coefficient of the topcoat layer is not particularly limited; however, the friction coefficient is preferably not more than 0.4. In a topcoat layer having such a low friction coefficient, when a load (sufficient load to produce scratches) is applied to the topcoat layer, the load can be released along the surface of the topcoat layer to reduce the frictional force to be produced by the load. In this manner, cohesion failure (damage, i.e., the topcoat layer is destroyed inside) and interfacial failure (damage, i.e., the topcoat layer peels off from the back face of the substrate) of the topcoat layer come to rarely occur. Therefore, if the friction coefficient of the topcoat layer is reduced, a phenomenon where a surface protective film is scratched can be more efficiently prevented. The lower limit of the friction coefficient is not particularly limited; however, the friction coefficient is properly not less than 0.1 (for example, not less than 0.1 and not more than 0.4) in consideration of balance between other properties (appearance quality, printability, etc.) and preferably not less than 0.15 (for example, not less than 0.15 and not more than 0.4). As the friction coefficient, for example, the value obtained by scratching the surface of the topcoat layer by a load of 40 mN vertically applied under a measurement environment of 23° C. and 50% RH, can be employed. The amount of wax ester (lubricant) used is preferably set such that the above preferable friction coefficient can be realized. To control the friction coefficient, for example, it is also efficient to increase the crosslinking density of the topcoat layer by adding a crosslinking agent and/or controlling film formation conditions.

The surface protective film of the present invention preferably has the back face (the surface of the topcoat layer) which is easily printable with oily ink (for example, by an oily marking pen). Such a surface protective film is suitable for printing identification numbers, etc. of objects to be protected on the surface protective film during processing and transportation of the objects (such as an optical component) with the surface protective film laminated thereto. Therefore, the surface protective film having not only excellent appearance quality but also excellent printability is preferred. For example, the surface protective film preferably has high printability with oily ink containing a pigment in an alcohol solvent. In addition, it is preferable that ink of printed objects be rarely removed by scratch and transfer (in other words, printing adhesion is excellent). The surface protective film of the present invention preferably has solvent resistance to the extent that no remarkable change is given in appearance even if printing is wiped out with an alcohol. (for example, ethyl alcohol) in correcting or erasing the printing. The degree of solvent resistance can be determined, for example, by solvent resistance evaluation described later.

In the surface protective film of the present invention, the topcoat layer contains a wax ester as a lubricant. Accordingly, even if a release treatment (for example, a treatment in which a release agent known in the art, such as a silicone release agent and a long-chain alkyl release agent, is applied and dried) is not further applied to the surface of the topcoat layer, sufficient lubricating property (for example, the aforementioned preferable friction coefficient) can be obtained. The embodiment where a release treatment is not further applied to the surface of the topcoat layer is preferable since whitening (for example, whitening caused by storing under heating and humidifying conditions) caused by a release agent can be prevented in advance. In addition, this is also advantageous in view of solvent resistance.

<Acrylic Adhesive Layer>

In the surface protective film of the present invention, the acrylic adhesive layer (acrylic pressure-sensitive adhesive layer) is formed from a water dispersible acrylic adhesive composition (water dispersible acrylic pressure-sensitive adhesive composition) (water dispersible acrylic adhesive composition for removal) (sometimes referred to as “the adhesive composition of the present invention”) essentially containing the following acrylic emulsion polymer. It is preferable that the adhesive composition of the present invention further contain a water-insoluble crosslinking agent having not less than two functional groups capable of reacting with a carboxyl group in a molecule (in one molecule).

<Acrylic Emulsion Polymer>

In the adhesive composition of the present invention, the acrylic emulsion polymer is a polymer (acrylic polymer) constituted of an alkyl (meth)acrylate (A) and a carboxyl group-containing unsaturated monomer (B) as essential raw-material monomers (raw-material monomer components). In other words, the acrylic emulsion polymer is a polymer that can be obtained from a monomer mixture containing an alkyl (meth)acrylate (A) and a carboxyl group-containing unsaturated monomer (B) as essential components. The acrylic emulsion polymers can be used alone or in combination with not less than two types. Note that, in the specification, the “(meth)acryl” refers to “acryl” and/or “methacryl” (either one or both of “acryl” and “methacryl”)

Of them, the acrylic emulsion polymer is not particularly limited; however, the acrylic emulsion polymer is preferably a polymer constituted of an alkyl (meth)acrylate (A), a carboxyl group-containing unsaturated monomer (B) and at least one monomer (C) selected from the group consisting of methyl methacrylate, vinyl acetate and diethylacrylamide, as essential raw-material monomers, in order to reduce defective appearance (dents, etc.) of the adhesive layer. In other words, it is preferable that the acrylic emulsion polymer be a polymer obtained from a monomer mixture containing an alkyl (meth)acrylate (A), a carboxyl group-containing unsaturated monomer (B) and at least one monomer (C) selected from the group consisting of methyl methacrylate, vinyl acetate and diethylacrylamide, as essential components. The acrylic emulsion polymers can be used alone or in combination with not less than two types. Note that, in the specification, “at least one monomer (C) selected from the group consisting of methyl methacrylate, vinyl acetate and diethylacrylamide” is sometimes simply referred to as “monomer (C)”. If not less than two types of monomers selected from the group consisting of methyl methacrylate, vinyl acetate and diethylacrylamide are included in the all raw-material monomers constituting the acrylic emulsion polymer, all of them are specified as the monomer (C).

If the adhesive layer in the surface protective film has defective appearance (poor appearance characteristics such as dents, etc. present in the surface and occurrence of variation in thickness of the adhesive layer), the appearance characteristics of the surface protective film may become poor, and when the appearance of an object is inspected with such a surface protective film laminated thereto, inspection accuracy might reduce. Note that the reduction in inspection accuracy sometimes negatively affects productivity.

The alkyl (meth)acrylate (A) is used as a main monomer component and plays a role in expressing basic properties as an adhesive (or adhesive layer) mainly including adhesiveness and peel property. Of them, an alkyl acrylate imparts flexibility to a polymer forming an adhesive layer and tends to exert an effect of helping the adhesive layer to express adhesion and adhesiveness; whereas, an alkyl methacrylate imparts rigidness to a polymer forming an adhesive layer and tends to exert an effect of controlling removability of the adhesive layer. The alkyl (meth)acrylate (A) is not particularly limited; however, an alkyl (meth)acrylate having a linear, branched or cyclic alkyl group having carbon atoms of 2 to 16 (more preferably 2 to 10 and further preferably 4 to 8) is mentioned. It should be noted that methyl methacrylate is not included in the alkyl (meth)acrylate (A).

Of them, as an alkyl acrylate, for example, an alkyl acrylate having an alkyl group having carbon atoms of 2 to 14 (more preferably 4 to 9) is preferable. Examples thereof include alkyl acrylates having a linear or branched alkyl group, such as n-butyl acrylate, isobutyl acrylate, s-butyl acrylate, isoamyl acrylate, hexyl acrylate, heptyl acrylate, octyl acrylate, 2-ethylhexyl acrylate, isooctyl acrylate, nonyl acrylate and isononyl acrylate. Of them, 2-ethylhexyl acrylate is preferable.

As the alkyl methacrylate, for example, an alkyl methacrylate having an alkyl group having carbon atoms of 2 to 16 (more preferably 2 to 10) is preferred. Examples thereof include alkyl methacrylates having a linear or branched alkyl group, such as ethyl methacrylate, propyl methacrylate, isopropyl methacrylate, n-butyl methacrylate, isobutyl methacrylate, s-butyl methacrylate and t-butyl methacrylate; and alicyclic alkyl methacrylate such as cyclohexyl methacrylate, bornyl methacrylate and isobornyl methacrylate.

The alkyl (meth)acrylates (A) can be appropriately selected depending upon a desired adhesiveness or the like. The alkyl (meth)acrylates (A) can be used alone or in combination with not less than two types.

The content of the alkyl (meth) acrylate (A) is 70 wt % to 99.5 wt % based on the total amount (whole amount) (100 wt %) of the raw-material monomers (all raw-material monomers) constituting the acrylic emulsion polymer, preferably 70 wt % to 99 wt %, more preferably 85 wt % to 98 wt % and further more preferably 87 wt % to 96 wt %. The content is preferably not less than 70 wt %, since adhesiveness and removability of the adhesive layer improve. In contrast, if the content exceeds 99.5 wt %, the contents of the carboxyl group-containing unsaturated monomer (B) and the monomer (C) reduce, with the result that the appearance of the adhesive layer formed of the adhesive composition sometimes becomes poor. Note that if not less than two types of alkyl (meth)acrylates (A) are used, it is sufficient if the total amount (whole amount) of all alkyl (meth)acrylates (A) satisfies the above range.

The carboxyl group-containing unsaturated monomer (B) can form a protective layer on the surface of emulsion particles formed of the acrylic emulsion polymer and exert a function of preventing shear fracture of the particles. The effect is further improved by neutralizing a carboxyl group with a base. Note that stability of particles against shear fracture is more generally called as mechanical stability. Furthermore, if one or not less than two types of water-insoluble crosslinking agents capable of reacting with carboxyl groups are used in combination, the carboxyl group-containing unsaturated monomer (B) can serve as a crosslinking point in the stage of forming an adhesive layer by removing water and further can improve adhesion (anchor effect) to a substrate via the water-insoluble crosslinking agent. Examples of such a carboxyl group-containing unsaturated monomer (B) include (meth)acrylic acids (acrylic acid, methacrylic acid), itaconic acid, maleic acid, fumaric acid, crotonic acid, carboxyethyl acrylate and carboxypentyl acrylate. Note that the carboxyl group-containing unsaturated monomer (B) includes unsaturated monomers containing an acid anhydride group, such as maleic anhydride and itaconic anhydride. Of them, an acrylic acid is preferable since the relative concentration on the surface of particles is high and further denser protective layer is easily formed. Note that the carboxyl group-containing unsaturated monomers (B) can be used alone or in combination with not less than two types.

The content of the carboxyl group-containing unsaturated monomer (B) is 0.5 wt % to 10 wt % based on the total amount (whole amount) (100 wt %) of the raw-material monomers (all raw-material monomers) constituting the acrylic emulsion polymer, preferably 1 wt % to 5 wt % and more preferably 2 wt % to 4 wt %. The content is preferably not more than 10 wt %, since an increase of interaction with a functional group on the surface of an object, i.e., a polarizing plate, after the adhesive layer is formed, can be suppressed to suppress an increase of adhesive force with the passage of time and improve peel property. Furthermore, if the content exceeds 10 wt %, the carboxyl group-containing unsaturated monomer (B) (for example, acrylic acid) is sometimes polymerized in water and may contribute to an increase of viscosity (viscosity increase), since it is generally soluble in water. In contrast, the content is preferably not less than 0.5 wt %, since the mechanical stability of emulsion particles improves. Also, if the content is not less than 0.5 wt %, adhesion (anchor effect) between the adhesive layer and the substrate improves and adhesive deposit can be suppressed.

The monomer (C) (methyl methacrylate, vinyl acetate and diethylacrylamide) mainly plays a role in reducing defective appearance (dents, etc.) of the adhesive layer. These monomers (C) are polymerized with another monomer during polymerization and the polymerized product forms emulsion particles. Thus, the stability of the emulsion particles increases and a gelatinized product (aggregate) decreases. In addition, affinity for hydrophobic water-insoluble crosslinking agent increases, dispersibility of emulsion particles is improved, and dents due to poor dispersibility are thus reduced.

The content of the monomer (C) is not particularly limited; however, the content is preferably 0.5 wt % to 10 wt % based on the total amount (whole amount) (100 wt %) of the raw-material monomers (all raw-material monomers) constituting an acrylic emulsion polymer, more preferably 1 wt % to 6 wt % and further preferably 2 wt % to 5 wt %. The content is preferably not less than 0.5 wt %, since the monomer (C) can sufficiently exert its effect (effect of suppressing poor appearance). If the content is not more than 1.0 wt %, the polymer forming the adhesive layer becomes relatively flexible and adhesion to an object improves. Note that if not less than two types of monomers selected from the group consisting of methyl methacrylate, vinyl acetate and diethylacrylamide are contained in the all raw-material monomers constituting the acrylic emulsion polymer, the total of contents (total content) of methyl methacrylate, vinyl acetate and diethylacrylamide is specified as the “content of monomer (C)”.

As the raw-material monomer constituting the acrylic emulsion polymer, another monomer component other than the monomer components [alkyl (meth)acrylate (A), carboxyl group-containing unsaturated monomer (B), monomer (C)] may be used in combination with them for the purpose of imparting a predetermined function. As such a monomer component, for the purpose of improving crosslinking within an emulsion particle and cohesive force, for example, epoxy group-containing monomers such as glycidyl (meth)acrylate; and polyfunctional monomers such as trimethylpropane tri(meth)acrylate and divinyl benzene each may be added (used) in an amount of less than 5 wt %. Note that the amount added (used) refers to the content based on the total amount (100 wt %) of the raw-material monomers (all raw-material monomers) constituting the acrylic emulsion polymer.

The amount of a hydroxyl group-containing unsaturated monomer added (used), such as 2-hydroxyethyl acrylate and 2-hydroxypropyl acrylate, serving as the another monomer component, is preferably low in order to further reduce white-staining. More specifically, the addition amount of hydroxyl group-containing unsaturated monomer (the content thereof based on the total amount (whole amount) (100 wt %) of the raw-material monomers (all raw-material monomers) constituting the acrylic emulsion polymer) is preferably less than 1 wt %, more preferably less than 0.1 wt % and further preferably substantially 0 (for example, less than 0.05 wt %). However, in order to introduce a crosslinking point in crosslinking of a hydroxyl group and an isocyanate group, metal crosslinking and the like, the amount added (used) may be about 0.01 to 10 wt %.

The acrylic emulsion polymer is obtained by emulsion polymerization of the raw-material monomers (monomer mixture) with the help of an emulsifier and a polymerization initiator.

The emulsifier to be used in emulsion polymerization of the acrylic emulsion polymer is a reactive emulsifier having a radical polymerizable functional group introduced in a molecule (reactive emulsifier containing a radical polymerizable functional group). More specifically, the acrylic emulsion polymer is an acrylic emulsion polymer obtained by polymerization using a reactive emulsifier having a radical polymerizable functional group in a molecule. The reactive emulsifiers containing a radical polymerizable functional group can be used alone or in combination with not less than two types.

The reactive emulsifier containing a radical polymerizable functional group (hereinafter referred to as a “reactive emulsifier”) is an emulsifier containing at least one radical polymerizable functional group in its molecule (in one molecule). The reactive emulsifier is not particularly limited and one or not less than two types selected from various reactive emulsifiers containing a radical polymerizable functional group such as a vinyl group, a propenyl group, an isopropenyl group, a vinylether group (a vinyloxy group) and an allyl ether group (an allyloxy group) can be used. An emulsifier is incorporated into a polymer by use of the reactive emulsifier and staining derived from the emulsifier reduces. In addition, if a reactive emulsifier is used, whitening (whitening by moisture absorption) of the acrylic adhesive layer formed of the adhesive composition of the present invention during storage while humidifying is suppressed. Therefore, the surface protective film according to the present invention is particularly suitable for use in protecting the surface of an optical component such as an optical film.

As the reactive emulsifier, a reactive emulsifier having a configuration (or corresponding to a configuration) obtained by introducing a radical polymerizable functional group (radical reactive group) such as a propenyl group and an allyl ether group into a nonionic anionic emulsifier (anionic emulsifier having a nonionic hydrophilic group) such as sodium polyoxyethylene alkyl ether sulfate, ammonium polyoxyethylene alkyl phenyl ether sulfate, sodium polyoxyethylene alkyl phenyl ether sulfate and sodium polyoxyethylene alkyl sulfo-succinate, is mentioned. Note that hereinafter, the reactive emulsifier having a configuration obtained by introducing a radical polymerizable functional group into an anionic emulsifier will be referred to as an “anionic reactive emulsifier”. Whereas, the reactive emulsifier having a configuration obtained by introducing a radical polymerizable functional group into a nonionic anionic emulsifier will be referred to as a “nonionic anionic reactive emulsifier”.

Particularly, when an anionic reactive emulsifier (of them, a nonionic anionic reactive emulsifier) is used, staining resistance can be improved, since the emulsifier is incorporated into a polymer. Furthermore, particularly when the water-insoluble crosslinking agent (described later) is a polyfunctional epoxy crosslinking agent having an epoxy group, the reactivity of the crosslinking agent can be improved by its catalytic function. When an anionic reactive emulsifier is not used, a crosslinking reaction is not completed by aging and the following problem sometime occurs: the adhesive force of the adhesive layer varies with the passage of time. Moreover, since the anionic reactive emulsifier is incorporated into a polymer, the emulsifier does not precipitate on the surface of an object unlike a quaternary ammonium compound (for example, see Japanese Patent Laid-Open No. 2007-31585) generally used as a catalyst for an epoxy crosslinking agent. Therefore, the anionic reactive emulsifier would not be a cause of white-staining and is thus preferred.

As such a reactive emulsifier, commercially available products can be used. Examples thereof include trade name: “Adekaria soap SE-10N” (manufactured by ADEKA Corp.), trade name: “Aqualon HS-10” (manufactured by Dai-ichi Kogyo Seiyaku Co., Ltd.), and trade name: “Aqualon HS-05” (manufactured by Dai-ichi Kogyo Seiyaku Co., Ltd.).

Since impurity ions particularly produce problems in some cases, it is desirable that impurity ions are removed and that a reactive emulsifier having an SO₄²⁻ ion concentration of not more than 100 μg/g is used. In the case of an anionic reactive emulsifier, an ammonium salt reactive emulsifier is desirably used. As a method for removing impurities from a reactive emulsifier, an appropriate method such as an ion exchange resin method, a membrane separation method and a precipitation filtration method of impurities with an alcohol, can be used.

The amount of the reactive emulsifier blended (used) is preferably 0.1 part by weight to 10 parts by weight relative to the total amount (whole amount) (100 parts by weight) of the raw-material monomers (all raw-material monomers) constituting the acrylic emulsion polymer, more preferably 0.5 parts by weight to 6 parts by weight, and further preferably 1 part by weight to 4.5 parts by weight. The amount is preferably not less than 0.1 parts by weight, since stable emulsion can be maintained. The amount is preferably not more than 10 parts by weight, since the solvent-insoluble content of the acrylic adhesive layer after crosslinking can be easily controlled to fall within the range specified by the present invention to thereby improve the cohesive force of the adhesive (adhesive layer), resulting in suppression of staining to an object. If the amount is not more than 10 parts by weight, staining with the emulsifier also can be suppressed.

The polymerization initiator to be used in emulsion polymerization of the acrylic emulsion polymer is not particularly limited. Examples thereof that can be used include azo-based polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropioneamidine)disulfate and 2,2′-azobis(N,N′-dimethyleneisobutylamidine); persulfates such as potassium persulfate and ammonium persulfate; peroxide polymerization initiators such as benzoyl peroxide, t-butyl hydroperoxide and hydrogen peroxide; and redox initiators such as a combination of a peroxide and a reducing agent, for example, redox polymerization initiators such as a combination of a peroxide and ascorbic acid (a combination of hydrogen peroxide water and ascorbic acid, etc.), a combination of a peroxide and an iron (II) salt (a combination of hydrogen peroxide water and an iron (II) salt, etc.) and a combination of a persulfate and sodium hydrogensulfite. Note that the polymerization initiators can be used alone or in combination with not less than two types.

The amount of the polymerization initiator blended (used) can be appropriately determined depending upon the type of initiator and the types of raw-material monomers and is not particularly limited; however, the amount is preferably 0.01 part by weight to 1 part by weight and more preferably 0.02 to 0.5 parts by weight relative to the total amount (whole amount) (100 parts by weight) of the raw-material monomers (all raw-material monomers) constituting the acrylic emulsion polymer, in order to control the solvent-insoluble content of the acrylic adhesive layer to fall within preferable ranges, etc.

In the emulsion polymerization of the acrylic emulsion polymer, any polymerization method such as a general batch polymerization, a continuous drop polymerization and a fractionated drop polymerization can be used; however, the polymerization method is not particularly limited. Note that, in view of staining resistance and in order to control the solvent-insoluble content and breaking elongation of the acrylic adhesive layer after crosslinking to fall within the preferable ranges, etc., it is desirable that polymerization be performed by a batch polymerization at a low temperature (for example, not more than 55° C., preferably not more than 30° C.). If polymerization is performed in such conditions, a polymer having a high molecular weight is easily obtained and the amount of low molecular-weight polymer reduces. Presumably for this reason, staining reduces.

The acrylic emulsion polymer is a polymer having a constitutional unit derived from an alkyl (meth)acrylate (A) and a constitutional unit derived from a carboxyl group-containing unsaturated monomer (B) as essential constitutional units. Of them, the acrylic emulsion polymer is preferably a polymer containing a constitutional unit derived from an alkyl (meth)acrylate (A), a constitutional unit derived from a carboxyl group-containing unsaturated monomer (B) and a constitutional unit derived from a monomer (C), as essential constitutional units. The content of the constitutional unit derived from an alkyl (meth)acrylate (A) in the acrylic emulsion polymer is preferably 70 wt % to 99.5 wt %, more preferably 70 wt % to 99 wt %, further preferably 85 wt % to 98 wt % and further more preferably 87 wt % to 96 wt %. The content of constitutional unit derived from a carboxyl group-containing unsaturated monomer (B) in the acrylic emulsion polymer is preferably 0.5 wt % to 10 wt %, more preferably 1 wt % to 5 wt % and further preferably 2 wt % to 4 wt %. The content of constitutional unit derived from a monomer (C) in the acrylic emulsion polymer is preferably 0.5 wt % to 10 wt %, more preferably 1 wt % to 6 wt % and further more preferably 2 wt % to 5 wt %.

The solvent-insoluble content in the acrylic emulsion polymer (the ratio of a solvent-insoluble component; sometimes referred to as “gel fraction”) is preferably not less than 70% (wt %), more preferably not less than 75 wt % and further preferably not less than 80 wt %, in view of staining resistance and proper adhesive force. If the solvent-insoluble content is less than 70 wt %, low molecular-weight polymers are contained in a large amount in the acrylic emulsion polymer, and therefore the low-molecular weight component in an adhesive layer cannot be sufficiently and effectively reduced merely by crosslinking. Thus, an object is stained with the low-molecular weight component or the like, and adhesive force becomes excessively high in some cases. The solvent-insoluble content can be controlled, for example, by a polymerization initiator, a reaction temperature, the type of emulsifier and the types of raw-material monomers. The upper limit of the solvent-insoluble content is not particularly limited; however, the upper limit is, for example, 99 wt %.

Note that in the present invention, the solvent-insoluble content of the acrylic emulsion polymer is a value calculated by the following “solvent-insoluble content measuring method”.

(Solvent-Insoluble Content Measuring Method)

An acrylic emulsion polymer (about 0.1 g) is taken, wrapped with a porous tetrafluoroethylene sheet (trade name: “NTF1122”, manufactured by NITTO DENKO CORPORATION) having an average pore diameter of 0.2 μm, and thereafter bound with kite string and then weighed. The weight is regarded as the weight before soaking. Note that the weight before soaking is the total weight of the acrylic emulsion polymer (taken above), the tetrafluoroethylene sheet and kite string. In addition, the total weight of the tetrafluoroethylene sheet and the kite string is measured and regarded as the wrapper weight.

Then, the wrapped acrylic emulsion polymer in the tetrafluoroethylene sheet and bound with kite string (referred to as a “sample”) is placed in a 50 ml-container filled with ethyl acetate and allowed to stand still at 23° C. for 7 days. Thereafter, the sample (treated with ethyl acetate) is taken out from the container, transferred to a cup made of aluminum, dried at 130° C. for 2 hours in a dryer to remove ethyl acetate. Thereafter, the weight of the sample is measured and regarded as the weight after soaking.

The solvent-insoluble content is calculated in accordance with the following formula:

solvent-insoluble content (wt %)=(a−b)/(c−b)×100 (1)

wherein, a represents the weight after soaking, b the wrapper weight and c the weight before soaking.

The weight average molecular weight (Mw) of a solvent-soluble content (sometimes referred to as a “sol content”) in the acrylic emulsion polymer is not particularly limited; however, Mw is preferably 40,000 to 200,000, more preferably 50,000 to 150,000 and further preferably 60,000 to 100,000. If the weight average molecular weight of the solvent-soluble content of an acrylic emulsion polymer is not less than 40,000, the wettability of an adhesive composition to an object improves and adhesiveness thereof to the object improves. Furthermore, if the weight average molecular weight of the solvent-soluble content in an acrylic emulsion polymer is not more than 200,000, the residue level of the adhesive composition on an object reduces and staining resistance improves.

The weight average molecular weight of a solvent-soluble content in the acrylic emulsion polymer can be obtained by subjecting a sample (a solvent-soluble content in the acrylic emulsion polymer), which is obtained by drying the treatment solution (ethyl acetate solution) treated with ethyl acetate and obtained in measurement of the solvent-insoluble content in the acrylic emulsion polymer, in air at normal temperature, to GPC (gel permeation chromatographic) measurement. As a specific measuring method, the following method is mentioned.

[Measuring Method]

GPC measurement is performed by use of a GPC apparatus “HLC-8220GPC”, manufactured by Tohso Corporation, to obtain a polystyrene-equivalent molecular weight. Measurement conditions are as follows.

Sample concentration: 0.2 wt % (THF solution)

Amount of sample injected: 10 μL

Eluent: THF

Flow rate: 0.6 mL/min

Measurement temperature: 40° C.

Column:
Sample column; TSK guard column Super HZ-H (single column)+TSK gel Super HZM-H (two columns)
Reference column; TSK gel Super H-RC (single column)

Detector: Differential refractometer

In the adhesive composition of the present invention, the content of the acrylic emulsion polymer is not particularly limited; however, the content is preferably not less than 80 wt % relative to the nonvolatile content (100 wt %) of the adhesive composition and more preferably 90 wt % to 99 wt %.

<Water-Insoluble Crosslinking Agent>

As described above, it is preferable that the adhesive composition of the present invention further contain a water-insoluble crosslinking agent having not less than two functional groups capable of reacting with a carboxyl group in a molecule (in one molecule), in addition to the acrylic emulsion polymer. The water-insoluble crosslinking agent is a water insoluble compound having not less than two (for example, 2 to 6) functional groups capable of reacting with a carboxyl group, in a molecule (in one molecule). The number of functional groups capable of reacting with a carboxyl group in a molecule is preferably 3 to 5. The larger the number of functional groups capable of reacting with a carboxyl group in a molecule, the more densely the adhesive composition is crosslinked (in other words, the polymer forming the adhesive layer has more densely crosslinked structure). Because of this, wet spreading of the adhesive layer after formed can be prevented. Furthermore, since the polymer forming the adhesive layer is constrained, it is possible to prevent the functional group (carboxyl group) in the adhesive layer from being segregated on the surface of an object to increase the adhesive force between the adhesive layer and the object with the passage of time. In contrast, if the number of functional groups capable of reacting with a carboxyl group in a molecule is excessively larger, i.e., more than 6, a gelatinized product is sometimes produced.

In the water-insoluble crosslinking agent, the functional group capable of reacting with a carboxyl group is not particularly limited; however, for example, an epoxy group, an isocyanate group, and a carbodiimide group are mentioned. Of them, in view of reactivity, an epoxy group is preferable. Furthermore, a glycidylamino group is preferable because the glycidylamino group is favorable in view of staining resistance (an unreacted product rarely remains in a crosslinking reaction since the reactivity is high) and because an increase of adhesive force to an object with the passage of time can be prevented by the presence of an unreacted carboxyl group in the adhesive layer. In short, as the water-insoluble crosslinking agent, an epoxy crosslinking agent having an epoxy group is preferred. Of them, a crosslinking agent (glycidylamino crosslinking agent) having a glycidylamino group is preferred. Note that, if the water-insoluble crosslinking agent is an epoxy crosslinking agent (particularly glycidylamino crosslinking agent), the number of epoxy groups (particularly glycidylamino groups) in a molecule is not less than two (for example, 2 to 6) and preferably 3 to 5.

The water-insoluble crosslinking agent is a water insoluble compound. Note that the “water insoluble” means that the solubility of a compound at 25° C. to water (100 parts by weight) (in other words, the weight of a compound (a crosslinking agent) that can be dissolved in 100 parts by weight of water) is not more than 5 parts by weight, preferably not more than 3 parts by weight and further preferably not more than 2 parts by weight. If a water-insoluble crosslinking agent is used, a crosslinking agent remaining un-crosslinked rarely causes white-staining on an object under a high-humidity environment, improving staining resistance. In the case of a water-soluble crosslinking agent, the remaining crosslinking agent is dissolved in water under a high-humidity environment and easily transferred to an object. Thus, white-staining tends to occur. Furthermore, the water-insoluble crosslinking agent more highly contributes to a crosslinking reaction (reaction with a carboxyl group) than a water-soluble crosslinking agent and thus highly effectively prevents an increase of adhesive force with the passage of time. Moreover, the water-insoluble crosslinking agent has a high crosslinking reactivity. Thus, a crosslinking reaction swiftly proceeds just by aging and an increase of adhesive force to an object with the passage of time can be prevented by the presence of an unreacted carboxyl group in an adhesive layer.

Note that the solubility of a crosslinking agent to water can be measured, for example, as follows.

(Method of Measuring Solubility to Water)

Water (25° C.) and a crosslinking agent (the same weights) are mixed by use of a stirrer at a rotation number of 300 rpm for 10 minutes and the mixture is centrifugally separated into a water phase and an oily phase. Subsequently, the water phase is recovered and dried at 120° C. for one hour. The content of a nonvolatile content in the water phase (nonvolatile components (parts by weight) relative to the water (100 parts by weight)) is obtained based on weight loss on drying.

Specific examples of the water-insoluble crosslinking agent include glycidylamino crosslinking agents such as 1,3-bis(N,N-diglycidylaminomethyl)cyclohexane (for example, trade name: “TETRAD-C”, manufactured by Mitsubishi Gas Chemical Company, Inc.) [solubility to water (100 parts by weight) at 25° C. is not more than 2 parts by weight], and 1,3-bis(N,N-diglycidylaminomethyl)benzene (for example, trade name: “TETRAD-X”, manufactured by Mitsubishi Gas Chemical Company, Inc.) [solubility to water (100 parts by weight) at 25° C. is not more than 2 parts by weight]; and other epoxy crosslinking agents such as tris(2,3-epoxypropyl) isocyanurate (for example, trade name: “TEPIC-G”, manufactured by Nissan Chemical Industries, Ltd.) [solubility to water (100 parts by weight) at 25° C. is not more than 2 parts by weight]. Note that the water-insoluble crosslinking agents can be used alone or in combination with not less than two types.

The amount of the water-insoluble crosslinking agent blended (the content thereof in the adhesive composition of the present invention) is preferably determined such that the mole number of the functional groups capable of reacting with the carboxyl groups of the water-insoluble crosslinking agent relative to one mole of the carboxyl groups of a carboxyl group-containing unsaturated monomer (B) to be used as a raw-material monomer of the acrylic emulsion polymer, becomes 0.4 mole to 1.3 mole. More specifically, [functional groups capable of reacting with a carboxyl group/carboxyl groups](mole ratio), that is, the ratio of “the total mole number of functional groups capable of reacting with all carboxyl groups of water-insoluble crosslinking agent” relative to “the total mole number of all carboxyl groups of the carboxyl group-containing unsaturated monomer (B) to be used as a raw-material monomer of the acrylic emulsion polymer” is preferably 0.4 to 1.3, more preferably 0.5 to 1.1 and further preferably 0.5 to 1.0. The [functional groups capable of reacting with a carboxyl group/carboxyl groups] is preferably not less than 0.4, since the number of unreacted carboxyl groups in the adhesive layer can be reduced to effectively prevent an increase of adhesive force with the passage of time due to the interaction between the carboxyl groups and an object. Also, if the [functional groups capable of reacting with a carboxyl group/carboxyl groups] is not less than 0.4, the solvent-insoluble content and breaking elongation of the acrylic adhesive layer after crosslinking are easily controlled to fall within the ranges specified by the present invention. In contrast, the [functional groups capable of reacting with a carboxyl groups/carboxyl group] is preferably not more than 1.3, since the amount of unreacted water-insoluble crosslinking agent in the adhesive layer can be reduced to suppress poor appearance due to the water-insoluble crosslinking agent and improve appearance characteristics.

Particularly, if the water-insoluble crosslinking agent is an epoxy crosslinking agent, the [epoxy group/carboxyl group](mole ratio) is preferably 0.4 to 1.3, more preferably 0.5 to 1.1 and further preferably 0.5 to 1.0. Whereas, if the water-insoluble crosslinking agent is a glycidylamino crosslinking agent, it is preferable that the [glycidylamino group/carboxyl group](mole ratio) satisfy the above ranges.

Note that, for example, if 4 g of a water-insoluble crosslinking agent whose equivalent of the functional groups capable of reacting with a carboxyl group is 110 (g/eq) is added (blended) to an adhesive composition, the mole number of functional groups capable of reacting with a carboxyl group that the water-insoluble crosslinking agent has can be calculated, for example, as follows:

The mole number of functional groups capable of reacting with a carboxyl group that the water-insoluble crosslinking agent has=[amount of water-insoluble crosslinking agent blended (added)]/[equivalent of functional group]=4/110.

For example, if 4 g of an epoxy crosslinking agent having an epoxy equivalent of 110 (g/eq) is added (blended) as the water-insoluble crosslinking agent, the mole number of epoxy groups that the epoxy crosslinking agent has can be calculated, for example, as follows:

The mole number of epoxy groups that the epoxy crosslinking agent has=[amount of the epoxy crosslinking agent blended (added)]/[epoxy equivalent]4/110.

<Water Dispersible Acrylic Adhesive Composition>

The adhesive composition of the present invention contains the acrylic emulsion polymer as an essential component, as described above. It is preferable that the water-insoluble crosslinking agent be contained. Furthermore, if necessary, other various types of additives may be contained.

The adhesive composition of the present invention is a water dispersible adhesive composition. Note that the “water dispersible” refers to being dispersible in an aqueous medium. In other words, the adhesive composition of the present invention is an adhesive composition dispersible in an aqueous medium. The aqueous medium refers to a medium (dispersion medium) containing water as an essential component and may not only consist of water alone but also be a mixture of water and a water-soluble organic solvent. Note that the adhesive composition of the present invention may be a dispersion solution using the aqueous medium, etc.

Note that it is preferable that the adhesive composition of the present invention do not substantially contain a so-called non-reactive (non-polymerizable) component (except a component which is vaporized by drying and does not remain in the adhesive layer, such as water) other than a reactive (polymerizable) component which reacts (polymerizes) with the raw-material monomers of an acrylic emulsion polymer, etc., and is incorporated into a polymer forming an adhesive layer. If such a non-reactive component remain in the adhesive layer, the component transfers to an object and sometimes cause white-staining. Note that “does not substantially contain” means that a component is not purposely added except for the cases where a component is inevitably mixed. More specifically, the content of such a non-reactive component in the adhesive composition (nonvolatile content) is preferably less than 1 wt %, more preferably less than 0.1 wt % and further preferably less than 0.005 wt %.

As an example of the non-reactive component, a component, which bleeds out to the surface of the adhesive layer to impart peel property, such as a phosphate compound, for example, used in Japanese Patent Laid-Open No. 2006-45412, is mentioned. Furthermore, non-reactive emulsifiers such as sodium lauryl sulfate and ammonium lauryl sulfate are mentioned.

Specifically, it is preferable that a quaternary ammonium salt be not added to the adhesive composition of the present invention, and further preferable that a quaternary ammonium compound be not added, in view of staining resistance. Accordingly, the adhesive composition of the present invention preferably contains substantially no quaternary ammonium salt and further preferably contains substantially no quaternary ammonium compound. These compounds are generally used as a catalyst, etc. for improving the reactivity of epoxy crosslinking agents. However, since these compounds are not incorporated into a polymer forming an adhesive layer and can freely migrate in the adhesive layer, they easily precipitate on an object surface. If such compounds are contained in an adhesive composition, white-staining tends to easily occur and staining resistance cannot be attained in some cases. More specifically, the content of a quaternary ammonium salt in the adhesive composition of the present invention is preferably less than 0.1 wt % relative to 100 wt % of the adhesive composition (nonvolatile content), more preferably less than 0.01 wt % and further preferably less than 0.005 wt %. Furthermore, it is preferable that the content of a quaternary ammonium compound satisfy the above ranges.

Note that the quaternary ammonium salt is not particularly limited; however, the quaternary ammonium salt is more specifically a compound represented, for example, by the following formula:

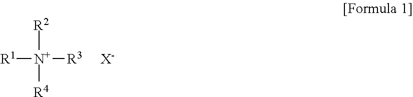

In the formula, R¹, R², R³ and R⁴ each represent: an alkyl group, an aryl group or a group derived from these (for example, an alkyl group and aryl group having a substituent) except a hydrogen atom; and X⁻ represents a counter ion.

Examples of the quaternary ammonium salt and the quaternary ammonium compound include, but not particularly limited to, alkyl ammonium hydroxides such as tetramethylammonium hydroxide (TMAH), tetraethylammonium hydroxide, tetrapropylammonium hydroxide and tetrabutylammonium hydroxide and salts thereof; aryl ammonium hydroxides such as tetraphenyl ammonium hydroxide and salts thereof; and bases containing cations such as a trilaurylmethylammonium ion, a didecyldimethylammonium ion, a dicocoyldimethylammonium ion, a distearyldimethylammonium ion, a dioleyldimethylammnonium ion, a cetyltrimethylanonium ion, a stearyltrimethylamnonium ion, a behenyltrimethylammonium ion, a cocoylbis(2-hydroxyethyl)methylammonium ion, a polyoxyethylene (15) cocostearylmethylarnmonium ion, an oleylbis(2-hydroxyethyl)methylammonium ion, a cocobenzyldimethylammonium ion, a laurylbis(2-hydroxyethyl)methylammonium ion and a decylbis(2-hydroxyethyl)methylammonium ion, and salts thereof.

It is preferable that a tertiary amine and an imidazole compound, which are generally used as a catalyst, etc. for improving reactivity of an epoxy crosslinking agent, be not added to the adhesive composition of the present invention, similarly to the cases of the quaternary ammonium salt (or quaternary ammonium compound), in view of staining resistance. Accordingly, it is preferable that the adhesive composition of the present invention substantially contain neither a tertiary amine nor an imidazole compound. More specifically, the content of the tertiary amine and the imidazole compound (the total content of the tertiary amine and the imidazole compound) in the adhesive composition of the present invention is preferably less than 0.1 wt % relative to 100 wt % of the adhesive composition (nonvolatile content), more preferably less than 0.01 wt % and further preferably less than 0.005 wt %.

Examples of the tertiary amine include tertiary amine compounds such as triethylamine, benzyldimethylamine and ca-methylbenzyl-dimethylamine. Examples of the imidazole compounds include 2-methylimidazole, 2-heptadecylimidazole, 2-phenylimidazole, 4-ethylimidazole, 4-dodecylimidazole, 2-phenyl-4-hydroxymethylimidazole, 2-ethyl-4-hydroxymethyl imidazole, 1-cyanoethyl-4-methyl imidazole and 2-phenyl-4,5-dihydroxymethyl imidazole.

Note that the adhesive composition of the present invention may contain various types of additives other than the aforementioned ones as long as they do not influence staining properties. Examples of the various types of additives include a pigment, a filler, a leveling agent, a dispersant, a plasticizer, a stabilizer, an antioxidant, a UV absorber, a UV stabilizer, a defoaming agent, an anti-aging agent and an antiseptic.

The adhesive composition of the present invention can be prepared by mixing the acrylic emulsion polymer, if necessary, the water-insoluble crosslinking agent and other various types of additives. As the mixing method, an emulsion mixing method commonly employed in the art can be used, and the mixing method is not particularly limited; however, for example, stirring by a stirrer is preferred. Stirring conditions are not particularly limited; however, for example, the temperature is preferably 10° C. to 50° C. and more preferably 20° C. to 35° C.; and the stirring time is preferably 5 minutes to 30 minutes and more preferably 10 minutes to 20 minutes. The rotation number in stirring is preferably 10 rpm to 3000 rpm and more preferably 30 rpm to 1000 rpm.

In the surface protective film of the present invention, an adhesive layer (acrylic adhesive layer) can be formed of the adhesive composition of the present invention. A method for forming the acrylic adhesive layer is not particularly limited, and a method for forming an adhesive layer routinely used in the art can be used. For example, an acrylic adhesive layer can be formed by applying the adhesive composition of the present invention on a substrate (transparent film substrate) or a release film (release liner), if necessary, drying and/or hardening it. As a specific method for drying and/or hardening the composition, for example, a method including drying by heating under a temperature condition of 70 to 160° C. for 10 seconds to 10 minutes is mentioned. Crosslinking is performed after a drying step (dewatering and drying) by e.g., warming the acrylic adhesive layer.

Note that in the method of forming the acrylic adhesive layer, the adhesive composition can be applied in accordance with a coating method commonly known in the art using a coater conventionally used such as a gravure-roll coater, a reverse-roll coater, a kiss-roll coater, a dip-roll coater, a bar coater, a knife coater, a spray coater, a comma coater and a direct coater.

In the surface protective film of the present invention, the thickness of the acrylic adhesive layer is not particularly limited; however, the thickness is preferably 1 μm to 50 μm, more preferably 1 μm to 35 μm and further preferably 3 μm to 25 μm.

In the surface protective film of the present invention, the solvent-insoluble content of the acrylic adhesive layer (after crosslinked) is not particularly limited; however, the content is preferably not less than 90 wt % and more preferably not less than 95 wt %. The content of a solvent-insoluble content is preferably not less than 90 wt %, since transfer of stain to an object is suppressed to suppress white-staining and insufficiency of removability (heavy release). The upper limit of solvent-insoluble content of the acrylic adhesive layer is not particularly limited; however, the upper limit is preferably, for example, 99 wt %. Note that the solvent-insoluble content of the acrylic adhesive layer (after crosslinked) can be measured in the same manner as in a method for measuring the solvent-insoluble content of the aforementioned acrylic emulsion polymer, more specifically, in the same method as in the aforementioned “solvent-insoluble content measuring method” except that the “acrylic emulsion polymer” is rephrased by the “acrylic adhesive layer (after crosslinked)”.

In the surface protective film of the present invention, the breaking elongation (elongation of fracture point) of the acrylic adhesive layer at 23° C. is preferably not more than 130%, more preferably 40% to 120% and further preferably 60% to 115%. The breaking elongation (elongation of fracture point) is an indication showing the degree of crosslinking of an acrylic adhesive layer. If the breaking elongation is not more than 130%, the polymer forming the acrylic adhesive layer has more densely crosslinked structure and therefore, wet spreading of the acrylic adhesive layer can be prevented. Furthermore, since the polymer forming the acrylic adhesive layer is constrained, it is possible to prevent the functional group (carboxyl group) in the acrylic adhesive layer from being segregated on the surface of an object to increase the adhesive force to the object with the passage of time.

Note that the breaking elongation (elongation of fracture point) of the acrylic adhesive layer (after crosslinking) at 23° C. can be measured by a tensile test. The breaking elongation can be obtained, specifically for example, but not limited to, by a measuring method including rolling the acrylic adhesive layer (after crosslinking) to prepare a cylindrical sample (length: 50 mm, sectional area (bottom surface area): 1 mm²), subjecting the sample to a tensile test using a tensile tester under an environment of 23° C. and 50% RH in conditions of initial length (interval between chucks) of 10 mm, tensile rate of 50 mm/minute, and measuring the elongation of a fracture point.

The acrylic adhesive layer (after crosslinking) to be used in the tensile test can be prepared, more specifically for example, by the following method.

The acrylic adhesive layer is prepared by applying the adhesive composition of the present invention onto an appropriate release film such that the thickness of the dried layer becomes 50 μm, and then, drying the adhesive composition in a hot-air circulation oven at 120° C. for 2 minutes and allowing the resultant construct to stand still (aging) at 50° C. for 3 days. The release film is not particularly limited; however, a PET film whose surface is treated with silicone can be used. As a commercially available product, e.g., “MRF38” manufactured by Mitsubishi Plastics, Inc. may be mentioned.

Furthermore, the glass-transition temperature of an acrylic polymer (after crosslinking) forming the acrylic adhesive layer, is not particularly limited; however, the glass-transition temperature is preferably −70° C. to −10° C., more preferably −70° C. to −20° C., further preferably −70° C. to −40° C. and most preferably −70° C. to −60° C. The glass-transition temperature is preferably not more than −10° C., since satisfactory adhesive force is obtained to suppress lifting and peeling during processing, etc. The glass-transition temperature is preferably not less than −70° C., since the drawback of heavy release leading reduction of working efficiency can be suppressed even if peeling rate (tensile rate) is within a high rate range. The glass-transition temperature of an acrylic polymer (after crosslinked) forming the acrylic adhesive layer can be also controlled depending upon, for example, the monomer composition for preparing an acrylic emulsion polymer.

The surface protective film of the present invention may have, if necessary, a release liner, which is to be laminated to the adhesive face (a surface protective film laminated with a release liner) in order to protect the adhesive face (the surface of the adhesive layer which is to be laminated to an object). The substrate constituting the release liner is not particularly limited; however, for example, a paper sheet and a synthetic resin film, are mentioned. Of them, a synthetic resin film is preferred since it has excellent surface smoothness. The substrate of a release liner, for example, is not particularly limited; however, various types of resin films (particularly polyester film) are preferably mentioned. The thickness of the release liner is not particularly limited; however, the thickness is preferably 5 μm to 200 μm and more preferably 10 μm to 100 μm. To the face of the release liner, which is to be laminated to an adhesive layer, a release treatment or an antifouling treatment may be applied with e.g., a release agent (for example, silicone, fluorine, a long-chain alkyl, and a fatty acid amide agents, etc.) generally known in the art or a silica powder.

<Performance of Surface Protective Film>

The surface protective film of the present invention preferably shows antistatic performance of within ±1 kV (more preferably within ±0.8 kV, further preferably within ±0.7 kV) in terms of peeling electrostatic charging voltage when the voltage is measured not only at the side of an object (polarizing plate) but also at the side of the surface protective film under a measurement environment of 23° C. and 50% RH. Particularly, the surface protective film of the present invention preferably shows antistatic performance of within ±1 kV (more preferably within ±0.8 kV, further preferably within ±0.7 kV) in terms of the peeling electrostatic charging voltage, when the voltage is measured not only at the side of an object but also at the side of the surface protective film under a measurement environment (low-humidity environment) of 23° C. and 25% RH. Preferably, in the surface protective film, at least the peeling electrostatic charging voltages measured at the side of the surface protective film both in 50% RH measurement conditions and 25% RH measurement conditions fall within ±0.1 kV.

The surface protective film of the present invention may further contain another layer in addition to a substrate, a topcoat layer and an acrylic adhesive layer. The “another layer” may be disposed e.g., between the first face (back face) of the substrate and the topcoat layer, between the second face (front face) of the substrate and the acrylic adhesive layer. The layer disposed between the substrate back-face and the topcoat layer may be, for example, a layer (antistatic layer) containing an antistatic component. The layer disposed between the substrate front-face and the acrylic adhesive layer may be, for example, an undercoat layer (anchor layer) for enhancing the anchor effect of the acrylic adhesive layer to the second face, or an antistatic layer. A surface protective film may be constituted by disposing an antistatic layer on the substrate front-face; an anchor layer on the antistatic layer; and an acrylic adhesive layer on the anchor layer.

In the surface protective film of the present invention, it is preferable that the topcoat layer 14 be provided directly on the back face 12A of the substrate 12, as shown, for example, in FIG. 1. In other words, it is preferable that another layer (for example, an antistatic layer) be not interposed between the substrate back-face 12A and the topcoat layer 14. Owing to the constitution, the adhesion between the substrate back-face 12A and the topcoat layer 14 can be enhanced compared to the constitution where another layer is interposed between the substrate back-face 12A and the topcoat layer 14. Accordingly, a surface protective film more excellent in scratch resistance is easily obtained.

The surface protective film of the present invention, as shown, for example, in FIG. 3, may be removed from the surface of an object by laminating an adhesive tape 60 to a back face 1A (a surface of topcoat layer 14) of the surface protective film 1 laminated to an object 50 and lifting at least a part of the surface protective film 1 from the object 50 through an operation of pulling the adhesive tape (pickup tape) 60 (pickup operation). The pickup tape 60 is not particularly limited; however, the pickup tape 60 is preferably a one-sided adhesive tape having a substrate 64 (preferably resin film) and an adhesive layer 62 provided to one of the sides of the substrate. The type of adhesive constituting the adhesive layer 62 is not particularly limited; however, for example, various types of adhesives such as an acrylic adhesive, a polyester adhesive, an urethane adhesive, a polyether adhesive, a rubber adhesive, a silicone adhesive, a polyamide adhesive and a fluorine adhesive, are mentioned. Note that such adhesives can be used alone or in combination with not less than two types. The thickness of the adhesive layer 62 is not particularly limited; however, the thickness is preferably 3 μm to 100 μm, more preferably 5 μm to 50 μm and further preferably 10 μm to 30 μm.

Herein, if the adhesive force of the pickup tape 60 (hereinafter, sometimes referred to as the “back-face peeling strength”) to the back face 1A of the surface protective film 1 greatly varies depending upon the type of adhesive constituting the adhesive layer 62, the degree of freedom in selecting the usable pickup tape 60 sometimes reduces. If the back-face peeling strength varies, a worker would be confused when he removes the surface protective film 1 from the object 50 by using the pickup tape 60, with the result that working efficiency might reduce and workload might increase. In the meantime, pickup tapes are generally dominated by acrylic pickup tapes having an adhesive layer formed of an acrylic adhesive (acrylic adhesive layer) and rubber pickup tapes having an adhesive layer formed of a rubber adhesive (rubber adhesive layer), in view of availability and cost. Thus, the surface protective film having a back-face peeling strength relatively similar to those of these two typical pickup tapes is preferred.

The topcoat layer of the surface protective film according to the present invention contains a wax ester as a lubricant. The topcoat layer formed of such a composition is preferred to the topcoat layer formed of a composition containing a silicone lubricant in place of the wax ester, for example, because the variation of the back-face peeling strength depending upon the type of adhesive layer of the pickup tape tends to be low (in other words, the dependency of the back-face peeling strength upon the pickup tape adhesive is low).

The substrate of the pickup tape is not particularly limited as long as the substrate has sufficient strength and flexibility to perform the pickup operation. For example, the same resin film as used in the substrate of the surface protective film is preferably mentioned. Other examples thereof include rubber sheets formed of a natural rubber and a butyl rubber, etc.; foam sheets obtained by foaming polyurethane, polychloroprene rubber and polyethylene, etc., paper sheets such as a kraft paper sheet, a crepe paper sheet and a Japanese paper sheet; cloth such as cotton cloth and staple fiber cloth; nonwoven cloth such as cellulosic nonwoven cloth, polyester nonwoven cloth and vinylon nonwoven cloth; metal foils such as an aluminum foil and a copper foil; and complexes thereof. The thickness of the substrate of the pick-up sheet can be appropriately selected depending upon the purpose; however, the thickness is preferably 10 μm to 500 μm and more preferably 10 μm to 200 μm.

In the surface protective film of the present invention, the adhesive force (180° peel test) (peel force in removing a surface protective film laminated to a polarizing plate) to a polarizing plate (triacetyl cellulose (TAC) plate) at a tensile rate of 30 m/minute, is not particularly limited; however, the adhesive force is preferably 0.05 N/25 mm to 2.0 N/25 mm, more preferably 0.1 N/25 mm to 2.0 N/25 mm, further preferably 0.2 N/25 mm to 1.5 N/25 mm, further more preferably 0.3 N/25 mm to 1.1 N/25 mm and most preferably 0.3 N/25 mm to 0.6 N/25 mm. If the adhesive force is not more than 2.0 N/25 mm, it is preferable since the surface protective film is rarely removed in a production step for a polarizing plate and a liquid crystal display device, thereby suppressing occurrence of a problem of a reduction in productivity and handling. In contrast, if the adhesive force is not less than 0.05 N/25 mm, it is preferable since lifting and peeling of the surface protective film rarely occur in the production step, with the result that the surface protective film is likely to exert a satisfactory protective function.

The whole light transmittance (according to JIS K7361-1) of the surface protective film of the present invention in a visible light wavelength region is not particularly limited; however, the whole light transmittance is preferably 80% to 97% and more preferably 85% to 95%. Furthermore, the haze of the surface protective film of the present invention (according to JIS K7136) is not particularly limited; however, the haze is preferably 0.2% to 3.5% and more preferably 2.0% to 3.2%.

As described above, since the surface protective film of the present invention contains a predetermined type of wax (more specifically, an ester of a higher fatty acid and a higher alcohol) as a lubricant, and has a topcoat layer containing a polyester resin as a binder thereof, whitening of the topcoat layer can be effectively suppressed even in high-temperature and high-humidity conditions. Furthermore, since the topcoat layer contains a lubricant, the topcoat layer has satisfactory scratch resistance as well as excellent whitening resistance. Because of this, the surface protective film of the present invention has high appearance quality.

The present invention, since it has an acrylic adhesive layer formed of the adhesive composition of the present invention, is excellent in adhesiveness, ability to prevent adhesive force from increasing with the passage of time and removability. In addition, poor appearance of the adhesive layer due to dents and defective air bubbles is somewhat overcome and the surface protective film rarely looks white. Because of this, the surface protective film is also excellent in appearance characteristics.

The surface protective film of the present invention, since appearance inspection of a product through the film can be accurately performed, can be preferably used as a surface protective film (surface protective film for optical parts) to protect the surfaces of the optical parts during processing and during transportation thereof, particularly by laminating it to optical parts (for example, optical parts used as liquid crystal display panel components such as a polarizing plate and a wavelength board; and conductive optical parts used as touch panel components such as an ITO film and ITO glass).

The surface protective film of the present invention, since it has excellent adhesiveness and removability (easy-to-peel property) and can be removed, can be preferably used for removal use (for removal). More specifically, the surface protective film of the present invention is preferably used for removal use [for example, masking tapes such as a masking tape for curing in construction, a masking tape for automobile painting, a masking tape for electronic parts (lead frame, print board, etc.) and a masking tape for sand blast; surface protective films such as a surface protective film for aluminum sash, a surface protective film for optical plastic, a surface protective film for optical glass, a surface protective film for protecting automobiles and a surface protective film for metal plates; adhesive tapes for use in production steps for semiconductors and electronic parts such as a back-grind tape, a pellicle fixing tape, a dicing tape, a lead frame fixing tape, a cleaning tape, a dust removing tape, a carrier tape and a cover tape; packing tapes for electronic equipment and electronic parts; temporary joint tapes during transportation; bonding tapes; and labels].

The surface protective film of the present invention reduces poor appearance of the adhesive layer due to e.g., dents and defective air bubbles. In addition, the surface protective film, since the film rarely looks white even though it has a topcoat layer, has excellent appearance characteristics. Furthermore, the surface protective film of the present invention can exhibit excellent scratch resistance because of the presence of the topcoat layer. For the reasons above, the adhesive sheet of the present invention is preferably used for protecting surfaces (surface protective film for optical components, etc.) of optical components (optical plastic, optical glass, optical film, etc.) such as a polarizing plate, a phase difference board, an anti-reflection board, a wavelength plate, an optical compensation film, a brightness improving film and a conductive film, which are used for constituting panels of devices required particularly excellent appearance characteristics and scratch resistance, etc., such as liquid crystal displays, organic electroluminescence (organic EL), field emission displays and touch panel displays. However, use is not limited to these. The surface protective film can be also used for protecting surface, preventing breakage or removal of foreign matter, etc., and masking, etc. in producing micro-machined parts such as semiconductors, circuits, various print boards, various masks and lead frames.

<Optical Component (Optical Member)>

The optical component of the present invention is an optical component to which the surface protective film is laminated. In other words, it is preferable that the optical component of the present invention have a structure in which the surface protective film provided on an optical component. Note that as the optical component, the aforementioned optical components are preferably mentioned.

Since the optical component of the present invention is constructed such that its surface is protected by the surface protective film, even if impact is unintentionally given to the optical component, breakage, etc. of the optical component can be prevented. Furthermore, the appearance of the optical component of the present invention can be accurately inspected even through the surface protective film. Moreover, in the optical component of the present invention, since the surface protective film is excellent in removability, breakage, etc. of the optical component would not occur in removing the surface protective film.

### EXAMPLES

Now, the present invention will be more specifically described based on Examples; however, the present invention is not limited by Examples. Furthermore, individual properties in the following description were measured or evaluated as follows.

[Measurement of Thickness of Topcoat Layer]

The surface protective film was stained with a heavy metal, embedded in a resin and sectioned by an ultrathin sectioning method. The section was observed by a transmission electron microscope (apparatus name: “H-7650”, manufactured by Hitachi High-Technologies Corporation) under conditions of an acceleration voltage of 100 kV, and magnification of 60,000, and a section image was taken and subjected to binarization processing. The sectional area of the topcoat is divided by a sample length within the field of vision to obtain the real thickness of the topcoat layer (average thickness within the field of vision).

[Evaluation of Whitening Resistance]

A researcher strongly rubbed the back face of a surface protective film (the surface of a topcoat layer) with a gloved hand once by a polyethylene terephthalate film of 38 μm in thickness and whether the rubbed portion (scratched portion) became transparent or not compared to the periphery (non-scratched portion) was visually observed. As a result, if the difference in transparency between the non-scratched portion and the scratched portion was able to be visually checked, it was determined that whitening was confirmed. If whitening occurs significantly, the contrast between the transparent scratched portion and its periphery (whitened non-scratched portion) becomes more distinctive as a phenomenon.

The visual observation was performed in a darkroom (reflection method, transmission method) and an illumination room, as follows:

(a) Observation by the reflection method in darkroom:

In a room (darkroom) which shut out incident of external light, a fluorescent lamp of 100 W (trade name: “Lupica line”, manufactured by MITSUBISHI ELECTRIC) was arranged at a distance of 100 cm from the back face (the surface of topcoat layer) of the surface protective film in each Example, and then, the back face of the sample was visually observed while switching an observing point.

(b) Observation by the transmission method in darkroom:

In the darkroom, the fluorescent lamp was arranged at a distance of 10 cm from the front face of the surface protective film (opposite surface to the surface on which the topcoat is provided) and the back face of the sample was visually observed while switching an observing point.

(c) Observation in illumination room:

In a room (illumination room) having a window upon which external light is incident, the back face of a sample was visually observed near a window on which sunlight did not directly strike, in clear-sky daytime.

Observation results under these three conditions were shown based on the following five stages.

0: whitening (difference in transparency between a scratched portion and a non-scratched portion) was not confirmed in any observation conditions.

1: Slight whitening was confirmed under observation by the reflection method in a darkroom.

2: Slight whitening was confirmed under observation by the transmission method in a darkroom.

3: Slight whitening was confirmed under observation in an illumination room.

4: Clear whitening was confirmed under observation in an illumination room.

The whitening resistance evaluation of surface protective films was performed in the initial period (after preparation, the films were stored under conditions of 50° C. and 15% RH for three days) and after warming and humidifying (after preparation, the films were stored under conditions of 50° C. and 15% RH for three days and then stored under high-temperature and high-humidity conditions of 60° C. and 95% RH for two weeks).

[Evaluation of Solvent Resistance]

In the darkroom as mentioned above, the back face of a surface protective film (more specifically, the surface of a topcoat layer) was wiped five times with waste cloth impregnated with ethyl alcohol and the appearance of the back face was visually observed. As a result, if no difference was observed in appearance between a portion wiped with ethyl alcohol and the other portion (if no appearance change due to wiping with ethyl alcohol was observed), the solvent resistance was evaluated as “satisfactory”; whereas if any irregularity was observed by wiping, the solvent resistance was evaluated as “unsatisfactory”.

[Measurement of Back-Face Peeling Strength]

As shown in FIG. 4, the surface protective film 1 was cut to prepare a piece of the surface protective film 1 having 70 mm in width and 100 mm in length. The surface protective film 1 thus obtained was fixed on a SUS 304 stainless steel plate 132 by use of a double-sided adhesive tape 130 with the adhesive face 20A (the face of the film having an adhesive layer provided thereon) of the film 1 faced to the stainless steel plate 132.

A one-sided adhesive tape (trade name: “Cellotape” (registered trade mark), manufactured by NICHIBAN Co., Ltd., width 24 mm) having a natural rubber adhesive on a cellophane film (substrate) was cut to obtain a tape having a length of 100 mm. The adhesive face 162A of the adhesive tape 160 thus obtained was pressure-bonded to the back face 1A (more specifically, the surface of the topcoat layer 14) of the surface protective film 1 by applying pressure of 0.25 MPa at a rate of 0.3 m/minute. This was allowed to stand still under conditions of 23° C. and 50% RH for 30 minutes. Thereafter, the adhesive tape 160 was peeled from the back face 1A of the surface protective film 1 by a universal tensile tester under conditions of a peeling rate of 0.3 m/minute and a peeling angle of 180°. At this time, the peeling strength [N/24 mm] was measured.

Note that the double-sided adhesive tape 130 is used for accurately measuring the back-face peeling strength, and more specifically, for preventing lift-up of the surface protective film 1 from the stainless steel plate 132, since the surface protective film 1 is pulled by the adhesive tape 160 when the adhesive tape 160 is peeled from the back face A of the surface protective film 1. Thus, a double-sided adhesive tape 130 which satisfies such a purpose can be appropriately selected and put in use. In the specification, the double-sided adhesive tape (trade name “No. 500A”, manufactured by NITTO DENKO CORPORATION) was used.

[Measurement of Peeling Strength of Surface Protective Film]

As an object, a plain polarizing plate (TAC polarizing plate, SEG1425DU, manufactured by NITTO DENKO CORPORATION) of 70 mm in width and 100 mm in length was prepared. A surface protective film was cut to obtain a piece of 25 mm in width and 100 mm in length. The adhesive face of the film thus obtained was pressure-bonded to the polarizing plate at a pressure of 0.25 MPa and a rate of 0.3 m/minute. After this was allowed to stand still under an environment of 23° C. and 50% RH for 30 minutes, the surface protective film was peeled from the polarizing plate by a universal tensile tester under the same environment and under conditions of a peeling rate of 30 m/minute and a peeling angle of 180°. At this time, the peeling strength (peeling strength to the polarizing plate) [N/25 mm] was measured.

The peeling strength of the surface protective film was measured in the initial period (immediately after the preparation) and after the film was stored in a 40° C. atmosphere for one week (after storage at 40° C. x one week).

[Evaluation of Ability to Prevent Adhesive Force from Increasing]

In measurement of peeling strength of the surface protective film, the difference between the “initial peeling strength of the surface protective film (initial peeling strength)” and the “peeling strength of the surface protective film after storage at 40° C.×one week (peeling strength of 40° C.×one week)” was obtained and evaluated in accordance with the following criteria.

Satisfactory (∘): case where difference is not more than 0.2 N/25 mm

Unsatisfactory (x): case where difference exceeds 0.2 N/25 mm

[Evaluation of Pick-Up Property] (Removability Evaluation)

The ratio of “back-face peeling strength” of the surface protective film and “peeling strength of the surface protective film after storage at 40° C.×one week (peeling strength of 40° C.×one week)”, i.e., [(back-face peeling strength)/(peeling strength of 40° C.×one week)], was obtained and evaluated in accordance with the following criteria.

More satisfactory ( [symbol] ): case where the ability to prevent adhesive force from increasing can be evaluated as satisfactory and the above ratio is not less than 3.8

Satisfactory (∘): case where the ability to prevent adhesive force from increasing can be evaluated as satisfactory and the above ratio is not less than 2.0

Unsatisfactory (x): case where the ability to prevent adhesive force from increasing can be evaluated as satisfactory and the above ratio is less than 2.0

[Evaluation of Surface Resistivity]

The surface resistance Rs of the back face of the surface protective film sample according to each of Examples was measured in accordance with JIS K6911 by an insulation resistance meter (trade name: “Hiresta-up MCP-HT450”, manufactured by MITSUBISHI CHEMICAL ANALYTECH Co., Ltd.) under an atmosphere of 23° C. and a relative humidity of 55%. The applied voltage was specified as 100V and reading of the surface resistance Rs was started 60 seconds after initiation of measurement. From this result, the surface resistivity was calculated in accordance with the following expression.

ρs=Rs×E/V×π(D+d)/(D−d)

where ρs represents surface resistivity (Ω), Rs surface resistance (Ω), E applied voltage (V), V measurement voltage (V), D the inner diameter (cm) of a surface circular electrode and d the outer diameter (cm) of an inner circle of the surface electrode.

[Breaking Elongation of Acrylic Adhesive Layer]

The water dispersible acrylic adhesive compositions (the following Adhesives 1 to 8) each were applied to a silicon-treated face of a PET film (trade name: “MRF38”, manufactured by Mitsubishi Plastics, Inc.) silicon-treated with silicone such that the thickness of the dried film became 50 μm, thereafter dried in a hot-air circulation oven at 120° C. for 2 minutes, and allowed to stand still (aging) at 50° C. for 3 days to prepare an acrylic adhesive layer having a thickness of 50 μm.

(Measurement of Breaking Elongation)

Subsequently, the acrylic adhesive layer was rolled to prepare a cylindrical sample (length: 50 mm, sectional area (bottom face area): 1 mm²).

Measurement was carried out using a tensile tester under an environment of 23° C. and 50% RH. Chucks were set such that initial length in the measurement (interval between chucks in the initial period) was 10 mm and a tensile test was performed in the condition: tensile rate of 50 mm/minute to measure elongation of a fracture point [breaking elongation (elongation of fracture point)].

Note that breaking elongation (elongation of fracture point) represents elongation when a test piece (cylindrical sample of an acrylic adhesive layer) is broken in the tensile test, and is calculated in accordance with the following expression.

“Breaking elongation (elongation of fracture point)” (%)=(“length of a test piece at the time of breaking (interval between chucks at the time of breaking)”−“initial length (10 mm)”)/“initial length (10 mm)”×100

[Solvent-Insoluble Content of Acrylic Adhesive Layer]

About 0.1 g of the adhesive layer (acrylic adhesive layer) was taken from a surface protective film, wrapped with a porous tetrafluoroethylene sheet (trade name: “NTF1122”, manufactured by NITTO DENKO CORPORATION) having an average pore diameter of 0.2 μm, and thereafter bound with kite string and then weighed. The weight was regarded as the weight before soaking. Note that the weight before soaking is the total weight of the acrylic adhesive layer (taken above), the tetrafluoroethylene sheet and kite string. In addition, the total weight of the tetrafluoroethylene sheet and the kite string was measured and regarded as the wrapper weight.

Then, the acrylic adhesive layer wrapped in the tetrafluoroethylene sheet and bound with kite string (referred to as a “sample”) was placed in a 50 ml-container filled with ethyl acetate and allowed to stand still at 23° C. for 7 days. Thereafter, the sample (treated with ethyl acetate) was taken out from the container, transferred to a cup made of aluminum, and dried at 130° C. for 2 hours in a dryer to remove ethyl acetate. Thereafter, the weight of the sample was measured and regarded as the weight after soaking.

The solvent-insoluble content is calculated in accordance with the following expression:

Solvent-insoluble content (wt %)=(d−e)/(f−e)×100

where d represents the weight after soaking, e the wrapper weight and f the weight before soaking.

(Production Example 1 of Water Dispersible Acrylic Adhesive Composition) (Adhesive 1)

To a container, water (90 parts by weight) and 2-ethylhexyl acrylate (2EHA) (94 parts by weight), methyl methacrylate (MMA) (2 parts by weight), acrylic acid (AA) (4 parts by weight) and a nonionic anionic reactive emulsifier (trade name: “Aqualon HS-10”, manufactured by Dai-ichi Kogyo Seiyaku Co., Ltd.) (6 parts by weight) were blended, as shown in Table 1. Thereafter the mixture was stirred and mixed by a homo mixer to prepare a monomer emulsion.

Subsequently, to a reaction container equipped with a condenser, a nitrogen inlet pipe, a thermometer and a stirrer, water (50 parts by weight), a polymerization initiator (ammonium persulfate) (0.01 part by weight) and 10 wt % of the monomer emulsion prepared above (amount corresponding to 10 wt %) were added. The mixture was subjected to emulsion polymerization performed at 75° C. for one hour while stirring. Thereafter, a polymerization initiator (ammonium persulfate) (0.07 parts by weight) was further added and then a whole amount (amount corresponding to 90 wt %) of the remaining monomer emulsion was added over 3 hours while stirring. After that, the reaction was performed at 75° C. for 3 hours. Subsequently, the reaction mixture was cooled to 30° C., and pH was controlled to be 8 by adding ammonia water having ammonia concentration of 10 wt % to prepare a water dispersion solution of an acrylic emulsion polymer.

To the thus obtained water dispersion solution of the acrylic emulsion polymer, a water-insoluble crosslinking agent, i.e., an epoxy crosslinking agent [trade name: “TETRAD-C”, 1,3-bis(N,N-diglycidylaminomethyl)cyclohexane, epoxy equivalent: 110, the number of functional groups: 4, manufactured by Mitsubishi Gas Chemical Company, Inc.](3 parts by weight) were added. The mixture was stirred and mixed by a stirrer under stirring condition of 23° C. and 300 rpm, for 10 minutes to prepare a water dispersible acrylic adhesive composition (sometimes referred to as “Adhesive 1”).

(Production Example 2 of Water Dispersible Acrylic Adhesive Composition) (Adhesive 2)

A water dispersible acrylic adhesive composition (sometimes referred to as “Adhesive 2”) was prepared in the same manner as in Production Example 1 of the water dispersible acrylic adhesive composition except that the monomer raw materials of the acrylic emulsion polymer were changed to 2-ethylhexyl acrylate (2EHA) (92 parts by weight), methyl methacrylate (MMA) (4 parts by weight) and acrylic acid (AA) (4 parts by weight); and the use amount of reactive emulsifier, i.e., “Aqualon HS-10” was changed to 3 parts by weight, as shown in Table 1.

(Production Example 3 of Water Dispersible Acrylic Adhesive Composition) (Adhesive 3)

A water dispersible acrylic adhesive composition (sometimes referred to as “Adhesive 3”) was prepared in the same manner as in Production Example 2 of the water dispersible acrylic adhesive composition except that the monomer raw materials of the acrylic emulsion polymer were changed to 2-ethylhexyl acrylate (2EHA) (88 parts by weight), methyl methacrylate (MMA) (8 parts by weight) and acrylic acid (AA) (4 parts by weight), as shown in Table 1.

(Production Example 4 of Water Dispersible Acrylic Adhesive Composition) (Adhesive 4)

A water dispersible acrylic adhesive composition (sometimes referred to as “Adhesive 4”) was prepared in the same manner as in Production Example 1 of the water dispersible acrylic adhesive composition except that the monomer raw materials of the acrylic emulsion polymer were changed to 2-ethylhexyl acrylate (2EHA) (92 parts by weight), vinyl acetate (Vac) (4 parts by weight) and acrylic acid (AA) (4 parts by weight); and “Adekaria soap SE-10N” (4.5 parts by weight) was used in place of “Aqualon HS-10”, as a reactive emulsifier, as shown in Table 1.

(Production Example 5 of Water Dispersible Acrylic Adhesive Composition) (Adhesive 5)

A water dispersible acrylic adhesive composition (sometimes referred to as “Adhesive 5”) was prepared in the same manner as in Production Example 1 of the water dispersible acrylic adhesive composition except that the monomer raw materials of the acrylic emulsion polymer were changed to 2-ethylhexyl acrylate (2EHA) (92 parts by weight), diethylacrylamide (DEAA) (4 parts by weight) and acrylic acid (AA) (4 parts by weight); and “Adekaria soap SE-10N” (3 parts by weight) was used in place of “Aqualon HS-10”, as a reactive emulsifier; and furthermore, use amount of “TETRAD-C” serving as water-insoluble crosslinking agent was changed to 4 parts by weight, as shown in Table 1.

(Production Example 6 of Water Dispersible Acrylic Adhesive Composition) (Adhesive 6)

A water dispersible acrylic adhesive composition (sometimes referred to as “Adhesive 6”) was prepared in the same manner as in Production Example 2 of the water dispersible acrylic adhesive composition except that “TETRAD-X” (3 parts by weight) was used in place of “TETRAD-C”, as a water-insoluble crosslinking agent, as shown in Table 1.

(Production Example 7 of Water Dispersible Acrylic Adhesive Composition) (Adhesive 7)

A water dispersible acrylic adhesive composition (sometimes referred to as “Adhesive 7”) was prepared in the same manner as in Production Example 1 of the water dispersible acrylic adhesive composition except that a non-reactive emulsifier, i.e., “LA-16”(4.5 parts by weight) was used in place of a reactive emulsifier, i.e., “Aqualon HS-10”, as shown in Table 1.

(Production Example 8 of Water Dispersible Acrylic Adhesive Composition) (Adhesive 8)

A water dispersible acrylic adhesive composition (sometimes referred to as “Adhesive 8”) was prepared in the same manner as in Production Example 2 of the water dispersible acrylic adhesive composition except that the monomer raw materials of the acrylic emulsion polymer were changed to 2-ethylhexyl acrylate (2EHA) (99.6 parts by weight) and acrylic acid (AA) (0.4 parts by weight).

TABLE 1

| | | | Adhesive | Adhesive | Adhesive | Adhesive | Adhesive | Adhesive | Adhesive | Adhesive |
|---|---|---|---|---|---|---|---|---|---|---|
| | | | 1 | 2 | 3 | 4 | 5 | 6 | 7 | 8 |
| Acrylic | Raw-material | 2EHA | 94 | 92 | 88 | 92 | 92 | 92 | 94 | 99.6 |
| emul- | monomer | MMA | 2 | 4 | 8 | — | — | 4 | 2 | — |
| sion | (parts by weight) | Vac | — | — | — | 4 | — | — | — | — |
| polymer | | DEAA | — | — | — | — | 4 | — | — | — |
| | | AA | 4 | 4 | 4 | 4 | 4 | 4 | 4 | 0.4 |
| | Polymerization | Ammonium | 0.08 | 0.08 | 0.08 | 0.08 | 0.08 | 0.08 | 0.08 | 0.08 |
| | initiator | persulfate | | | | | | | | |
| | (parts by weight) | | | | | | | | | |
| | Emulsifier | HS10 | 6 | 3 | 3 | — | 3 | 3 | — | 3 |
| | (parts by weight) | SE-10N | — | — | — | 4.5 | — | — | — | — |
| | | LA-16 | — | — | — | — | — | — | 4.5 | — |
| | Solvent insoluble content | | 81 | 85 | 86 | 82 | 85 | 85 | 75 | 78 |
| | (wt %) | | | | | | | | | |
| | Weight average molecular | | 80,000 | 100,000 | 100,000 | 70,000 | 80,000 | 100,000 | 100,000 | 160,000 |
| | weight of solvent soluble content | | | | | | | | | |
| Water | Acrylic emulsion polymer (A) | | 100 | 100 | 100 | 100 | 100 | 100 | 100 | 100 |
| dis- | (parts by weight) | | | | | | | | | |
| persible | Crosslinking | T/C | 3 | 3 | 3 | 3 | 4 | — | 3 | 0.3 |
| acrylic | agent | T/X | — | — | — | — | — | 3 | — | — |
| adhe- | (parts by weight) | | | | | | | | | |

| | | | | | | | | | |
|---|---|---|---|---|---|---|---|---|---|
| sive | Mole ratio of [epoxy group | 0.5 | 0.5 | 0.5 | 0.5 | 0.5 | 0.5 | 0.5 | 0.5 |
| compo- | (glycidylamino group) mole | | | | | | | | |
| sition | number)]/[carboxyl group | | | | | | | | |
| | mole number] | | | | | | | | |

In Table 1, the following expressions are more specifically as follows.

2EHA: 2-ethylhexyl acrylate

MMA: methyl methacrylate

Vac: vinyl acetate

DEAA: diethylacrylamide

AA: acrylic acid

HS10: nonionic anionic reactive emulsifier (trade name: “Aqualon HS-10”manufactured by Dai-ichi Kogyo Seiyaku Co., Ltd.)

SE-10N: nonionic anionic reactive emulsifier (trade name: “Adekaria soap SE-10N” manufactured by ADEKA Corp.)

LA-16: anionic non-reactive emulsifier (trade name: “Hitenol LA-16”, manufactured by Dai-ichi Kogyo Seiyaku Co., Ltd.)

T/C: epoxy crosslinking agent serving as a water-insoluble crosslinking agent: trade name: “TETRAD-C”, manufactured by Mitsubishi Gas Chemical Company, Inc., 1,3-bis(N,N-diglycidylaminomethyl) cyclohexane, epoxy equivalent: 110, the number of functional groups: 4

T/X: epoxy crosslinking agent serving as a water-insoluble crosslinking agent: trade name: “TETRAD-X”, manufactured by Mitsubishi Gas Chemical Company, Inc., 1,3-bis(N,N-diglycidylaminomethyl)benzene, epoxy equivalent: 100, the number of functional groups: 4

### Example 1

### Preparation of Coating Material

A dispersion solution (binder dispersion solution) containing a polyester resin (25%) serving as a binder (trade name: “Vinarol MD-1480”, manufactured by Toyobo Co., Ltd., a water dispersion solution of a saturated copolyester resin) was prepared. Furthermore, a water dispersion solution containing carnauba wax serving as a lubricant (lubricant dispersion solution) was prepared. Moreover, an aqueous solution (an aqueous conductive polymer solution) (trade name: “Baytron P” manufactured by H. C. Stark) containing poly(3,4-dioxythiophene) (PEDOT) (0.5%) and polystyrene sulfonate (number average molecular weight: 150,000) (PSS)(0.8%) serving as a conductive polymer, was prepared.

To a water/ethanol solvent mixture, the binder dispersion solution (100 parts by weight on the solid basis), the lubricant dispersion solution (30 parts by weight on the solid basis), the aqueous conductive polymer solution (50 parts by weight on the solid basis) and a melamine crosslinking agent were added. The mixture was stirred for about 20 minutes and sufficiently mixed. In this manner, a coating material containing about 0.15% of NV was prepared.

(Formation of Topcoat Layer)

A transparent polyethylene terephthalate (PET) film (thickness: 38 μm, width: 30 cm, length: 40 cm) having a surface (first face) treated with corona was prepared. To the corona treated face of the PET film, the above coating material was applied by a bar coater and heated up to 130° C. for 2 minutes to dry. In this manner, a substrate (substrate with a topcoat) having a transparent topcoat layer of 10 nm in thickness on the first face of the PET film was prepared.

(Preparation of Surface Protective Film)

A release sheet was prepared by applying a release treatment with a silicone release agent onto one face of a PET film. On the release face (surface subjected to the release treatment) of the release sheet, Adhesive 1 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Example 2

### Preparation of Coating Material

A coating material containing NV (about 0.3%) was prepared in the same manner as in Example 1.

(Formation of Topcoat Layer)

A substrate having a transparent topcoat layer (substrate with a topcoat) of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 2 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Example 3

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 3 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Example 4

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 4 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Example 5

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 5 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50′C and 15% RH for three days to obtain a surface protective film.

### Example 6

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 6 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Comparative Example 1

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 7 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Comparative Example 2

### Preparation of Coating Material

A coating material containing NV (about 0.3%) was prepared in the same manner as in Example 1.

(Formation of Topcoat Layer)

A substrate (substrate with a topcoat) having a transparent topcoat layer of 50 nm in thickness on the first face of a PET film was prepared in the same manner as in Example 1.

(Preparation of Surface Protective Film)

A release sheet was prepared by applying a release treatment with a silicone release agent onto one face of a PET film. On the release face (surface subjected to the release treatment) of the release sheet, Adhesive 8 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

### Comparative Example 3

### Preparation of Coating Material

A solution containing an antistatic agent (trade name: “BONDEIP-P main agent”, manufactured by Konishi Co., Ltd.) composed of a cationic polymer and an epoxy resin (trade name: “BONDETP-P hardening agent”, manufactured by Konishi Co., Ltd.) serving as a hardening agent in a mass ratio of 100:46.7 on the NV basis in a water-alcohol solvent, was prepared.

(Formation of Topcoat Layer)

A transparent polyethylene terephthalate (PET) film (thickness: 38 μm, width: 30 cm, length: 40 cm) having a surface (first face) treated with corona was prepared. To the corona treated surface of the PET film, the coating material was applied by a bar coater and heated to 130° C. for 2 minutes to dry. In this manner, a transparent topcoat layer of 80 nm in thickness was obtained on the first face of the PET film.

Subsequently, to the surface of the topcoat layer, a long-chain alkyl carbamate release agent (trade name: “Peeloyl 1010”manufactured by Ipposha Oil Industries Co., Ltd.) was applied so as to provide 0.02 g/m² on the NV basis and dried to impart a lubricating property to the topcoat layer.

In this manner, a substrate (substrate with a topcoat) having a transparent topcoat layer of 80 nm in thickness on the first face of the PET film was prepared.

(Preparation of Surface Protective Film)

A release sheet was prepared by applying a release treatment with a silicone release agent onto one face of a PET film. On the release face (surface subjected to the release treatment) of the release sheet, Adhesive 9 (water dispersible acrylic adhesive composition) prepared above was applied and dried to form an acrylic adhesive layer of 15 μm in thickness. The adhesive layer was laminated to the other face of the substrate with a topcoat (second face, more specifically, the surface on which the topcoat layer is not provided) and then allowed to stand still (aging) under an environment of 50° C. and 15% RH for three days to obtain a surface protective film.

Schematic structure of the surface protective films according to Examples and Comparative Examples and the results of measurement or evaluation of these by the aforementioned methods are shown in Table 2.

TABLE 2

| | | | Example 1 | Example 2 | Example 3 | Example 4 | Example 5 |
|---|---|---|---|---|---|---|---|
| Schematic; | Substrate | | PET | PET | PET | PET | PET |
| structure | | | substrate | substrate | substrate | substrate | substrate |
| of | Topcoat | Binder | Polyester | Polyester | Polyester | Polyester | Polyester |
| surface | layer | Lubricant | Wax ester | Wax ester | Wax ester | Wax ester | Wax ester |
| protective | | Thickness [nm] | 10 | 50 | 50 | 50 | 50 |
| film | Adhesive | Type | Adhesive 1 | Adhesive 2 | Adhesive 3 | Adhesive 4 | Adhesive 5 |
| | layer | Thickness [μm] | 15 | 15 | 15 | 15 | 15 |
| | | Solvent insoluble | 97 | 97 | 97 | 97 | 98 |
| | | content (wt %) | | | | | |
| | | Breaking elongation | 105 | 103 | 91 | 112 | 104 |
| | | (%) | | | | | |

| Whitening resistance | Initial period | 0 | 0 | 0 | 0 | 0 |
|---|---|---|---|---|---|---|
| | After heating and | 2 | 1 | 1 | 1 | 1 |
| | humidifying | | | | | |
| Solvent resistance | | Satisfactory | Satisfactory | Satisfactory | Satisfactory | Satisfactory |
| Back-face peeling | | 7.0 | 6.4 | 6.4 | 6.4 | 6.4 |
| strength [N/24 mm] | | | | | | |
| Peeling strength | Initial period | 0.6 | 0.5 | 0.5 | 0.9 | 1.0 |
| (peeling strength against | 40° C. × one week | 0.6 | 0.6 | 0.5 | 0.9 | 1.1 |
| polarizing plate) | | | | | | |
| [N/25 mm] | | | | | | |

| | | | | | |
|---|---|---|---|---|---|
| Ability to prevent adhesive | Satisfactory | Satisfactory | Satisfactory | Satisfactory | Satisfactory |
| force from increasing | | | | | |
| Pick up property | More | More | More | More | More |
| | satisfactory | satisfactory | satisfactory | satisfactory | satisfactory |
| Surface resistivity [Ω/□] | 9.1 × 10⁸ | 6.3 × 10⁸ | 6.8 × 10⁸ | 6.6 × 10⁸ | 5.8 × 10⁸ |

| | | | | Comparative | Comparative | Comparative |
|---|---|---|---|---|---|---|
| | | | Example 6 | Example 1 | Example 2 | Example 3 |
| Schematic; | Substrate | | PET | PET | PET | PET |
| structure | | | substrate | substrate | substrate | substrate |
| of | Topcoat | Binder | Polyester | Polyester | Polyester | Epoxy resin |
| surface | layer | Lubricant | Wax ester | Wax ester | Wax ester | Long-chain |
| protective | | | | | | alkyl |
| film | | | | | | carbamate |
| | | Thickness [nm] | 50 | 50 | 50 | 80 |
| | Adhesive | Type | Adhesive 6 | Adhesive 7 | Adhesive 8 | Adhesive 5 |
| | layer | Thickness [μm] | 15 | 15 | 15 | 15 |
| | | Solvent insoluble | 97 | 90 | 82 | 98 |
| | | content (wt %) | | | | |
| | | Breaking elongation | 98 | 102 | 162 | 104 |
| | | (%) | | | | |

| | | | | | |
|---|---|---|---|---|---|
| Whitening resistance | Initial period | 0 | 0 | 0 | 0 |
| | After heating and | 1 | 1 | 1 | 4 |
| | humidifying | | | | |

| Solvent resistance | | Satisfactory | Satisfactory | Satisfactory | Satisfactory |
|---|---|---|---|---|---|
| Back-face peeling | | 6.4 | 6.4 | 6.4 | 1.0 |
| strength [N/24 mm] | | | | | |
| Peeling strength | Initial period | 0.6 | 0.5 | 3.8 | 1.0 |
| (peeling strength against | 40° C. × one week | 0.6 | 0.5 | 8.2 | 1.1 |
| polarizing plate) | | | | | |
| [N/25 mm] | | | | | |

| | | | | |
|---|---|---|---|---|
| Ability to prevent adhesive | Satisfactory | Satisfactory | Unsatisfactory | Satisfactory |
| force from increasing | | | | |
| Pick up property | More | More | Unsatisfactory | Unsatisfactory |
| | satisfactory | satisfactory | | |
| Surface resistivity [Ω/□] | 6.3 × 10⁸ | 5.8 × 10⁸ | 6.7 × 10⁸ | 5.8 × 10⁸ |

Note that if the pick-up property is “more satisfactory” (in other words, [(back-face peeling strength)/(peeling strength at 40° C.×one week)] is not less than 3.8), the pick-up performance at a high speed becomes more excellent. Because of this, the worker can make a pick-up operation faster and more efficiently and workability becomes excellent.

### REFERENCE SIGNS LIST

1: Surface protective film
1A: Surface (back face)
12: Substrate
12A: First face (back face)
12B: Second face (front face)
14: Topcoat layer
20: Adhesive layer (acrylic adhesive layer)
20A: Surface (adhesive face)
30: Release liner
50: Object
60: Adhesive tape (pickup tape)
62: Substrate
64: Adhesive layer
114: Topcoat layer
120A: Adhesive face
130: Double-sided adhesive tape
132: Stainless steel plate
160: Adhesive tape
162: Adhesive
162A: Adhesive face

1. A surface protective film comprising:
a substrate having a first face and a second face;
a topcoat layer formed on the first face of the substrate; and
an acrylic adhesive layer formed on the second face of the substrate, wherein
the topcoat layer contains a wax serving as a lubricant and a polyester resin serving as a binder,
the wax is an ester of a higher fatty acid and a higher alcohol, and
the acrylic adhesive layer is an adhesive layer formed of a water dispersible acrylic adhesive composition which contains:
an acrylic emulsion polymer which is constituted of, as essential raw-material monomers, an alkyl (meth)acrylate (A) and a carboxyl group-containing unsaturated monomer (B), the content of the alkyl (meth)acrylate (A) being 70 wt % to 99.5 wt % and the content of the carboxyl group-containing unsaturated monomer (B) being 0.5 wt % to 10 wt %, based on the total amount of the raw-material monomers, and which is obtained by polymerization using a reactive emulsifier containing a radical polymerizable functional group in a molecule.

2. The surface protective film according to claim 1, wherein the substrate is a polyester resin film.

3. The surface protective film according to claim 1, wherein the topcoat layer contains an antistatic component.

4. The surface protective film according to claim 1, wherein the water dispersible acrylic adhesive composition further contains a water-insoluble crosslinking agent containing not less than two functional groups capable of reacting with a carboxyl group in a molecule.

5. The surface protective film according to claim 1, wherein the acrylic emulsion polymer is an acrylic emulsion polymer constituted of an alkyl (meth)acrylate (A), a carboxyl group-containing unsaturated monomer (B) and at least one monomer (C) selected from the group consisting of methyl methacrylate, vinyl acetate and diethylacrylamide, as essential raw-material monomers.

6. The surface protective film according to claim 1, wherein a solvent-insoluble content of the acrylic emulsion polymer is not less than 70 wt %.

7. The surface protective film according to claim 1, wherein a solvent-insoluble content of the acrylic adhesive layer is not less than 90 wt % and a breaking elongation of the acrylic adhesive layer at 23° C. is not more than 130%.

8. The surface protective film according to claim 4, wherein the molar number of functional groups capable of reacting with a carboxyl group of the water-insoluble crosslinking agent per one mole of the carboxyl groups of the carboxyl group-containing unsaturated monomer (B) in the water dispersible acrylic adhesive composition is 0.4 moles to 1.3 moles.

9. The surface protective film according to claim 4, wherein the content of alkyl (meth)acrylate (A) is 70 wt % to 99 wt %, the content of the carboxyl group-containing unsaturated monomer (B) is 0.5 wt % to 10 wt % and the content of the monomer (C) is 0.5 wt % to 10 wt % based on the total amount of raw-material monomers constituting the acrylic emulsion polymer.

10. An optical component to which a surface protective film according to claim 1 is laminated.

11. The surface protective film according to claim 2, wherein the topcoat layer contains an antistatic component.

12. The surface protective film according to claim 2, wherein the water dispersible acrylic adhesive composition further contains a water-insoluble crosslinking agent containing not less than two functional groups capable of reacting with a carboxyl group in a molecule.

13. The surface protective film according to claim 3, wherein the water dispersible acrylic adhesive composition further contains a water-insoluble crosslinking agent containing not less than two functional groups capable of reacting with a carboxyl group in a molecule.

14. The surface protective film according to claim 2, wherein the acrylic emulsion polymer is an acrylic emulsion polymer constituted of an alkyl (meth)acrylate (A), a carboxyl group-containing unsaturated monomer (B) and at least one monomer (C) selected from the group consisting of methyl methacrylate, vinyl acetate and diethylacrylamide, as essential raw-material monomers.

15. The surface protective film according to claim 3, wherein the acrylic emulsion polymer is an acrylic emulsion polymer constituted of an alkyl (meth)acrylate (A), a carboxyl group-containing unsaturated monomer (B) and at least one monomer (C) selected from the group consisting of methyl methacrylate, vinyl acetate and diethylacrylamide, as essential raw-material monomers.

16. The surface protective film according to claim 2, wherein a solvent-insoluble content of the acrylic emulsion polymer is not less than 70 wt %.

17. The surface protective film according to claim 2, wherein a solvent-insoluble content of the acrylic adhesive layer is not less than 90 wt % and a breaking elongation of the acrylic adhesive layer at 23° C. is not more than 130%.

18. The surface protective film according to claim 5, wherein the molar number of functional groups capable of reacting with a carboxyl group of the water-insoluble crosslinking agent per one mole of the carboxyl groups of the carboxyl group-containing unsaturated monomer (B) in the water dispersible acrylic adhesive composition is 0.4 moles to 1.3 moles.

19. The surface protective film according to claim 5, wherein the content of alkyl (meth)acrylate (A) is 70 wt % to 99 wt %, the content of the carboxyl group-containing unsaturated monomer (B) is 0.5 wt % to 10 wt % and the content of the monomer (C) is 0.5 wt % to 10 wt % based on the total amount of raw-material monomers constituting the acrylic emulsion polymer.

20. An optical component to which a surface protective film according to claim 2 is laminated.
